(19) United States
(12) Patent Application Publication
(10) Pub. No.: US 2024/0298346 A1
(43) Pub. Date: Sep. 5, 2024

(54) L1 Signal to Activate PDCP Duplication

(71) Applicant: Telefonaktiebolaget LM Ericsson (publ), Stockholm (SE)

(72) Inventors: Zhenhua Zou, Solna (SE); Torsten Dudda, Wassenberg (DE)

(21) Appl. No.: 18/572,098

(22) PCT Filed: Jun. 22, 2022
(86) PCT No.: PCT/EP2022/067057

§ 371 Date: Dec. 19, 2023

Related U.S. Application Data
(60) Provisional application No. 63/213,867, filed on Jun. 23, 2021.

(51) Int. Cl. H04W 72/543; H04W 72/1263; H04W 72/232

(52) U.S. Cl. CPC H04W 72/543; H04W 72/1263; H04W 72/232

(57) ABSTRACT

A wireless communication network activates or deactivates PDCP duplication for a pre-configured RLC entity using L1 signaling, delivered in Downlink Control Information (DCI), transmitted up to every subframe on the Physical Downlink Control Channel (PDCCH). Hence. PDCP duplication can be activated or deactivated for a secondary RLC in the UE much faster than by using MAC CE or RRC. Upon receipt of the L1 signal, the UE activates or de-activates PDCP duplication for or more (or all) RLC entities.

### TECHNICAL FIELD

The present disclosure relates generally to wireless communication, and in particular to rapid (de)allocation of Packet Data Convergence Protocol (PDCP) in response to entering survival time due to missed packets, using Layer-1 signaling.

### BACKGROUND

Wireless communication networks, including network nodes and wireless devices such as cellphones and smartphones (also known as User Equipment, or UE), are ubiquitous in many parts of the world. These networks continue to grow in capacity and sophistication. To accommodate both more users and a wider range of types of devices that may benefit from wireless communications, the technical standards governing the operation of wireless communication networks continue to evolve. The fourth generation of network standards (4G, also known as Long Term Evolution, or LTE) has been deployed, the fifth generation (5G, also known as New Radio, or NR) is in development or early deployment, and the sixth generation (6G) is being planned. Technical standards defining the structure and operation of these networks are developed and promulgated by the Third Generation Partnership Project (3GPP), in a series of numbered Releases.

5G is being designed to provide service for multiple use cases, such as Enhanced Mobile Broadband (eMBB), Ultra-Reliable and Low Latency Communication (URLLC), and Machine-Type Communication (MTC). Each of these services has different technical requirements. For example, the general requirement for eMBB is high data rate with moderate latency and moderate coverage, while URLLC service requires low latency and high reliability transmission with moderate data rates.

One of the features to support these use cases is Packet Data Convergence Protocol (PDCP) packet duplication, as specified in 3GPP Technical Standard (TS) 38.300 v16.5.0, § 16.1.3. When PDCP packet duplication is configured for a Data Radio Bearer (DRB), at least one secondary Radio Link Control (RLC) entity, in addition to the primary RLC entity, is added to the DRB to handle the duplicated PDCP packet data units (PDUs). The logical channel (LCH) corresponding to the primary RLC entity is referred to as the primary LCH, and the LCH corresponding to a secondary RLC entity is referred to as a secondary LCH. A wireless device can be configured with multiple secondary RLC entities. When PDCP packet duplication is configured, the same PDCP PDUs are submitted multiple times-once to each activated RLC entity for the radio bearer. By providing multiple independent transmission paths, PDCP packet duplication increases reliability and reduces latency. This is particularly advantageous for URLLC services.

PDCP packet duplication is possible in Dual Connectivity (DC) and Carrier Aggregation (CA) protocol architectures. Both Radio Resource Control (RRC) signaling, and Medium Access Control (MAC) Control Elements (CEs) can be used to control activation/deactivation of packet duplication by the UE in uplink (UL) by the base station (gNB).

In the 5G Quality of Service (QOS) framework, a QoS flow is established in the 5G system and can be mapped to a DRB. The QoS flow is associated with QoS parameters (5G QoS Identifier (5QI) values) such as Packet Delay Budget (PDB). The 5G Radio Access Network (RAN) scheduling packets of this QoS flow (mapped to a DRB in 5G RAN) shall thus deliver packets within this PDB.

Another metric important in the industrial automation communication context, related to PDB, is so-called “survival time.” According to 3GPP TS 22.104 v18.0.0, survival time is defined as the time that an application consuming a communication service may continue without an anticipated message. The message is expected to be received by the application no later than at the end of the PDB, and the survival time is the maximum additional time that a message is expected after PDB.

For Time Sensitive Communication (TSC) traffic types (typical in industrial automation communication), 3GPP TS 23.501 v17.0.0 specifies TSC Assistance Information (TSCAI) signaling, which provides further information on the QoS flow traffic from the 5G core network to a RAN. This signaling includes information on UL/DL direction, periodicity, arrival time of a burst of data in this flow, and the survival time, see table 5.27.2-1 in the 3GPP TS 23.501 v17.0.0.

TABLE 5.27.2-1
TSC Assistance Information (TSCAI)

| Assistance | |
|---|---|
| Information | Description |
| Flow Direction | The direction of the TSC flow (uplink or downlink). |
| Periodicity | It refers to the time period between start of two bursts. |
| Burst Arrival | The latest possible time when the first packet of the data |
| time (Optional) | burst arrives at either the ingress of the RAN (downlink |
| | flow direction) or egress interface of the UE (uplink flow |
| | direction). |
| Survival Time | It refers to the time period an application can survive |
| (Optional) | without any burst, as defined in clause C.2.3 of |
| | TS 22.104. |

The survival time is typically expressed as an integer number of periodicities of the incoming traffic and the knowledge of the survival time can be beneficial for gNB to opportunistically schedule a least amount of radio resources to meet the QoS requirement of the traffic.

FIG. 1 depicts such an additional allocation of radio resources to meet QoS for a known survival time. The network schedules radio resources with normal allocation of Physical Resource Blocks (PRB) for the incoming packets with a nominal Packet Error Rate (PER) target. If a packet is not delivered within the Packet Delay Budget (PDB), causing the application to enter survival time mode, more radio resources are allocated for subsequent packets so that those packets are delivered within the survival time. In the example of FIG. 1, assume the first message is lost and not delivered to the application (as indicated by the “x” and dashed lines). This starts the survival time. The gNB allocates additional resources (in this case, additional PRBs), and the second message is delivered on time—that is, within the PDB. After successfully receiving one packet within the survival time, the application exits survival time mode, and resource allocations can return to the normal case, e.g., for delivery of the third message.

The network can transmit a dynamic re-scheduling command (e.g., dynamic UL grant or DL assignments) to allocate more resources for the subsequent packets. The dynamic re-scheduling command can only schedule transmission resources for subsequent packets on the same cell as the initial transmission. In the case of re-allocating the resources for the UL configured grant (CG) and DL Semi-Persistent Scheduling (SPS), it is restricted to the cell in which CG and SPS are configured. These restrictions can be insufficient to deliver the subsequent packets within the survival time if this cell (e.g., in FR2) may be subject to blocking. PDCP duplication on another cell is known to provide diversity gain and boost the packet transmission reliability.

However, PDCP duplication is activated only by the MAC CE or the RRC (re)-configuration, both of which are slow and not suitable for the case in which the survival time is short (e.g., 0.5 millisecond).

The Background section of this document is provided to place aspects of the present disclosure in technological and operational context, to assist those of skill in the art in understanding their scope and utility. Approaches described in the Background section could be pursued, but are not necessarily approaches that have been previously conceived or pursued. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of aspects of the disclosure or to delineate the scope of the invention. The sole purpose of this summary is to present some concepts disclosed herein in a simplified form as a prelude to the more detailed description that is presented later.

According to aspects disclosed herein, the network activates or deactivates PDCP duplication for a pre-configured RLC entity using L1 signaling, delivered in Downlink Control Information (DCI), transmitted up to every subframe on the Physical Downlink Control Channel (PDCCH). Hence, PDCP duplication can be activated or deactivated for a secondary RLC in the UE much faster than by using MAC CE or RRC. Upon receipt of the L1 signal, the UE activates or de-activates PDCP duplication for one or more (or all) RLC entities. In one example, the relevant RLC entity is configured by RRC, i.e., the logical channel config for the RLC entity contains a CG index.

One aspect relates to a method, performed by a wireless device operative in a wireless communication network, of transmitting uplink data packets using Packet Data Convergence Protocol (PDCP) packet duplication. In some aspects, the uplink data packets are transmitted in a Time Sensitive Communication (TSC) Quality of Service (QOS) flow. A primary Radio Link Control (RLC) entity and at least a first secondary RLC entity are configured for PDCP duplication in response to higher layer signaling from the network. A Layer-1 (L1) signal is received from the network, requesting one of activation or deactivation of PDCP duplication on the first secondary RLC entity. In response to the L1 signal, PDCP duplication is activated or deactivated, respectively, on the first secondary RLC entity.

Another aspect relates to a wireless device operative in a wireless communication network. The wireless device includes communication circuitry configured to wirelessly communicate with the network and processing circuitry operatively connected to the communication circuitry. The processing circuitry is configured to configure a primary Radio Link Control (RLC) entity and at least a first secondary RLC entity for Packet Data Convergence Protocol (PDCP) duplication in response to higher layer signaling from the network; receive a Layer-1 (L1) signal from the network requesting one of activation or deactivation of PDCP duplication on the first secondary RLC entity; and in response to the L1 signal, activate or deactivate, respectively, PDCP duplication on the first secondary RLC entity.

Yet another aspect relates to a method, performed by a base station operative in a wireless communication network, of receiving uplink data packets using Packet Data Convergence Protocol (PDCP) packet duplication. In some aspects, the uplink data packets are received in a Time Sensitive Communication (TSC) Quality of Service (QOS) flow. Configuration information is sent to a wireless device, via higher layer signaling, to configure a primary Radio Link Control (RLC) entity and at least a first secondary RLC entity for PDCP duplication. In response to failing to receive a periodic packet from the primary RLC entity within a predetermined Packet Delay Budget (PDB) after the packet arrival time, a command is sent to the wireless device, via L1 signaling, activating PDCP duplication for at least the first secondary RLC entity.

Still another aspect relates to a base station operative in a wireless communication network. The base station includes communication circuitry configured to wirelessly communicate with wireless devices and processing circuitry operatively connected to the communication circuitry. The processing circuitry is configured to send configuration information to a wireless device via higher layer signaling to configure a primary Radio Link Control (RLC) entity and at least a first secondary RLC entity for Packet Data Convergence Protocol (PDCP) packet duplication; and in response to failing to receive a periodic packet from the primary RLC entity within a predetermined Packet Delay Budget (PDB) after the packet arrival time, send a command to the wireless device, via L1 signaling, activating PDCP duplication for at least the first secondary RLC entity.

### BRIEF DESCRIPTION OF THE DRAWINGS

The present disclosure will now be described more fully hereinafter with reference to the accompanying drawings, in which aspects of the disclosure are shown. However, this disclosure should not be construed as limited to the aspects set forth herein. Rather, these aspects are provided so that this disclosure will be thorough and complete, and will fully convey the scope of the disclosure to those skilled in the art. Like numbers refer to like elements throughout.

FIG. 1 is a time diagram showing allocation of additional PRBs in response to survival time mode.

FIG. 2 is a block diagram showing secondary RLC activation.

FIG. 3 is a time diagram showing PDCP activation and deactivation in response to missed packet transmissions.

FIG. 4 is a flow diagram of a method of transmitting uplink data packets using PDCP packet duplication.

FIG. 5 is a flow diagram of a method of receiving uplink data packets using PDCP packet duplication

FIG. 6 is a hardware block diagram of a wireless device.

FIG. 7 is a functional block diagram of a wireless device.

FIG. 8 is a hardware block diagram of a base station.

FIG. 9 is a functional block diagram of a base station.

FIG. 10 is a block diagram of some elements of a wireless communication network.

FIG. 11 is a block diagram of a wireless device.

FIG. 12 is a schematic block diagram illustrating a virtualization environment.

FIG. 13 illustrates a telecommunication network connected via an intermediate network to a host computer.

FIG. 14 illustrates host computer communicating via a base station with a user equipment over a partially wireless connection.

FIG. 15 is a flowchart illustrating a host computer communicating with a UE in a communication system.

FIG. 16 is a flowchart illustrating a host computer communicating with a UE in a communication system.

FIG. 17 is a flowchart illustrating a UE communicating with a host computer in a communication system.

FIG. 18 is a flowchart illustrating communication between a base station and a host computer in a communication system.

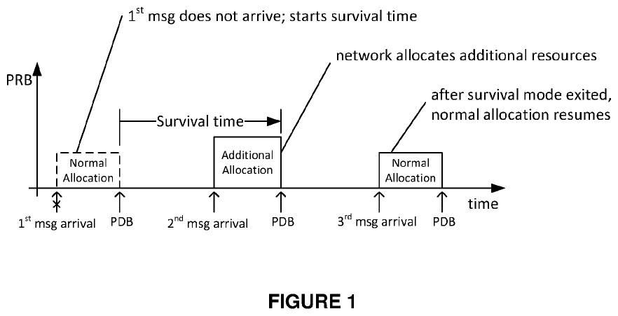

### DETAILED DESCRIPTION

For simplicity and illustrative purposes, the present disclosure is described by referring mainly to an exemplary aspect thereof. In the following description, numerous specific details are set forth in order to provide a thorough understanding of the present disclosure. However, it will be readily apparent to one of ordinary skill in the art that the present disclosure may be practiced without limitation to these specific details. In this description, well known methods and structures have not been described in detail so as not to unnecessarily obscure the present disclosure.

In one aspect, upon reception of a L1 signal (e.g., DCI transmitted on PDCCH), a UE activates PDCP duplication, and upon reception of another L1 signal, the UE de-activates PDCP duplication.

In one aspect, the first L1 signal is a configured grant (CG) type-2 activation DCI command and the second L1 signal is a configured grant (CG) type-2 deactivation DCI command.

In one aspect, the two L1 signals are used to activate/de-activate PDCP duplication for a secondary RLC entity for which there is an associated logical channel ID.

In one aspect, the secondary RLC entity to be activated/de-activated for PDCP duplication is RRC configured with a linkage/coupling between its logical channel ID and the CG index in the CG activation/deactivation command.

Alternatively to a linkage/coupling between LCHs/RLC entities and CG configurations, the linkage/coupling may also be defined between DRBs/PDCP entities and CG configurations. In this case all RLC entities for PDCP duplication associated with the DRB/PDCP entity, or a configured/default subset of RLC entities may be activated/deactivated for PDCP duplication.

In one aspect, the secondary RLC entity for PDCP duplication is for the data radio bears (DRB) but not signaling radio bears (SRB).

In one aspect, when a linkage/coupling between CG and RLC/LCH is configured for the UE, the UE shall be prepared to transmit PDCP duplicates via this RLC/LCH and CG as soon as the CG is activated. Therefore, PDCP duplicate data may be pre-processed and kept ready for transmission for the potential CG activation. For this pre-processing, the CG grant properties may be used (to determine e.g., transport block size). U.S. Provisional Patent Application No. 63/180,821, filed 28 Apr. 2021, titled “Selectively Enabling PDCP Duplication for Survival Time,” and assigned to the assignee of the present disclosure, describes the use of a deletion timer for a PDCP duplication leg that is not active. The timer duration is less than the time to the next subsequent periodic packet. Upon expiration of the deletion timer, the PDCP duplication leg discards a packet from its transmit buffer and obtains the next periodic packet. In this manner, when the PDCP duplication leg is activated, it is ready with current data to transmit. The disclosure of this provisional patent application is incorporated herein by reference, in its entirety.

In a network aspect, the network transmits the configured grant (CG) type-2 activation DCI command upon the detection that the survival time mode is entered, e.g., the loss of a UL periodic packet at the expected reception time.

In another network aspect, the network transmits the configured grant (CG) type-2 deactivation DCI command upon the detection that the survival time mode is not further needed, e.g., the correct reception of a UL periodic packet at the expected reception time.

In one RRC spec implementation example, the allowedCG-List-r16 in the RRC IE LogicalChannelConfig is used to configure the linkage/coupling. However, because the allowedCG-List-r16 is also used for LCP restriction, a separate “turn-on” parameter allowedCG-ListForPDCP-Duplication is used to indicate if allowedCG-List-r16 is also used to indicate the linkage/coupling:

```
-- ASN1START
-- TAG-LOGICALCHANNELCONFIG-START
LogicalChannelConfig ::= SEQUENCE {
  allowedCG-List-r16 SEQUENCE (SIZE (0.. maxNrofConfiguredGrantConfigMAC-
r16-1)) OF ConfiguredGrantConfigIndexMAC-r16 OPTIONAL, -- Need S
  ...
  [[
    allowedCG-ListForPDCP-Duplication ENUMERATED {true} OPTIONAL, --
Need R
  ]]
}
-- TAG-LOGICALCHANNELCONFIG-STOP
-- ASN1START
```

For the RLC entity configured for PDCP duplication and whose logical channel is configured with allowedCG-ListForPDCP-Duplication equal to true, if any configured grant, whose ConfiguredGrantConfigIndexMAC is in the allowedCG-list of this logical channel, is activated by the DCI command, then this RLC entity is activated for PDCP duplication. On the contrary, if, upon receiving the CG type 2 deactivation command, the result is that all configured grants whose ConfiguredGrantConfigIndexMAC are in the allowedCG-list of this logical channel, are de-activated, then this RLC entity is de-activated for PDCP duplication. It is further restricted that the field allowedCG-ListForPDCP-Duplication can only be configured (i.e., set to true) for the secondary RLC entity(es) of DRBs. If PDCP duplication is already activated/deactivated for this RLC entity when receiving the CG activation/deactivation indication, this indication is ignored.

In another RRC spec implementation example, a new field CGforPDCP-DuplicationList-r16 in the RRC IE LogicalChannelConfig is used to configure the linkage/coupling. In this example, there is no need to have a separate “turn-on” parameter.

-- ASN1START
-- TAG-LOGICALCHANNELCONFIG-START

| | |
|---|---|
| LogicalChannelConfig ::= | SEQUENCE { |

allowedCG-List-r16 SEQUENCE (SIZE (0.. maxNrofConfiguredGrantConfigMAC-
r16-1)) OF ConfiguredGrantConfigIndexMAC-r16

OPTIONAL, --

```
Need S
  ...
  [[
    CGforPDCP-DuplicationList SEQUENCE (SIZE (0..
maxNrofConfiguredGrantConfigMAC-r16-1)) OF ConfiguredGrantConfigIndexMAC-
r16
```

OPTIONAL, --

Need R
]]
}
-- TAG-LOGICALCHANNELCONFIG-STOP
-- ASN1START

For the RLC entity configured for PDCP duplication, if any configured grant, whose ConfiguredGrantConfigIndexMAC is in the CGforPDCP-DuplicationList, is activated by the DCI command, then this RLC entity is activated for PDCP duplication. On the contrary, if, upon receiving the CG type 2 deactivation command, the result is that all configured grants whose ConfiguredGrantConfigIndexMAC are in the CGforPDCP-DuplicationList, are deactivated, then this RLC entity is deactivated for PDCP duplication. It is further restricted that the field CGforPDCP-DuplicatoinList can only be present in the LogicalChannelConfig for the secondary RLC entity(es) of DRBs. If PDCP duplication is already activated/deactivated for this RLC entity when receiving the CG activation/deactivation indication, this indication ignored.

In yet another variant, the new field LCHs-to-activateList is included in the IE ConfiguredGrantConfig, indicating the LCHs/RLC entities for which PDCP duplication is to be activated/deactivated when CG activation/deactivation DCI is received for the configured grant RRC configured by ConfiguredGrantConfig.

In one MAC spec implementation example, the following (bold and underlined) is added in the subclause 5.10

If one or more DRBs are configured with PDCP duplication, the network may activate and deactivate the PDCP duplication for all or a subset of associated RLC entities for the configured DRB(s).

The PDCP duplication for the configured DRB(s) is activated and deactivated by:
receiving the Duplication Activation/Deactivation MAC CE described in clause 6.1.3.11;
receiving the Duplication RLC Activation/Deactivation MAC CE described in clause 6.1.3.32;
receiving a L1 signalling indicating configured uplink grant activation or deactivation for configured grant Type 2;
indication by RRC.
   The PDCP duplication for all or a subset of associated RLC entities for the configured DRB(s) is activated and deactivated by:
receiving the Duplication RLC Activation/Deactivation MAC CE described in clause 6.1.3.32;
receiving a L1 signalling indicating configured uplink grant activation or deactivation for configured grant Type 2;
indication by RRC.
   The MAC entity shall for each DRB configured with PDCP duplication:
1> if a Duplication Activation/Deactivation MAC CE is received activating the PDCP duplication of the DRB:
   2> indicate the activation of PDCP duplication of the DRB to upper layers.
1> if a Duplication Activation/Deactivation MAC CE is received deactivating the PDCP duplication of the DRB:
   2> indicate the deactivation of PDCP duplication of the DRB to upper layers.
1> if a Duplication RLC Activation/Deactivation MAC CE is received activating PDCP duplication for associated RLC entities of a DRB configured with PDCP duplication:
   2> indicate the activation of PDCP duplication for the indicated secondary RLC entity(ies) of the DRB to upper layers.
1> if a Duplication RLC Activation/Deactivation MAC CE is received deactivating PDCP duplication for associated RLC entities of a DRB configured with PDCP duplication:
   2> indicate the deactivation of PDCP duplication for the indicated secondary RLC entity(ies) of the DRB to upper layers.
1> if a L1 signalling indicating configured uplink grant activation for Type 2 is received
   2> For all secondary RLC entities that are configured with PDCP duplications, if the field CGForPDCP-Duplication is present and contains a configured grant index equal to the index in this L1 signalling for configured grant type 2
      3> indicate the activation of the PDCP duplication for the secondary RLC entity(ies) of the DRB to upper layers.
1> if a L1 signalling indicating configured uplink grant deactivation for Type 2 is received
   2> For all secondary RLC entities that are configured with PDCP duplications, if the field CGForPDCP-Duplication is present and none of the configured grant whose indexes are in the CGForPDCP-Duplication is activated
      3> indicate the deactivation of the PDCP duplication for the secondary RLC entity(ies) of the DRB to upper layers.

Another example with a different RRC configuration parameter is that
1> if a L1 signalling indicating configured uplink grant activation for Type 2 is received
   2> For all secondary RLC entities that are configured with PDCP duplications, if the field allowedCG-ListForPDCP-Duplication is present and allowedCG-List-r16 contains a configured grant index equal to the index in this L1 signalling for configured grant type 2
      3> indicate the activation of the PDCP duplication for the secondary RLC entity(ies) of the DRB to upper layers.
1> if a L1 signalling indicating configured uplink grant deactivation for Type 2 is received
   2> For all secondary RLC entities that are configured with PDCP duplications, if the field allowedCG-ListForPDCP-Duplication is present and none of the configured grant whose indexes are in the allowedCG-List-r16 is activated
      3> indicate the deactivation of the PDCP duplication for the secondary RLC entity(ies) of the DRB to upper layers.

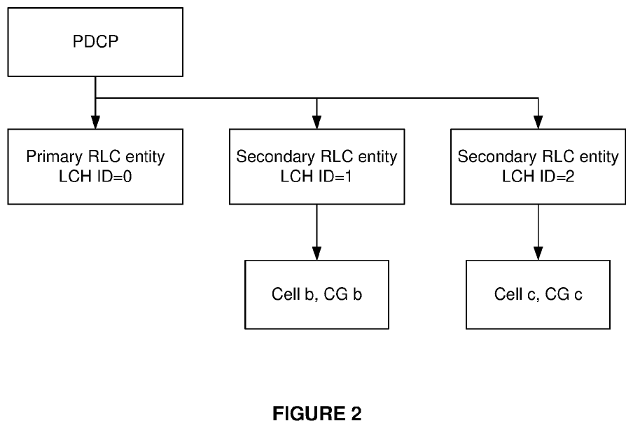

FIG. 2 depicts a PDCP configuration for a wireless device. In this example, the wireless device is configured for PDCP duplication with three RLC entities (i.e., three copies). A primary RLC entity has LCH ID=0. Two secondary RLC entities are configured, with LCH ID=1 and LCH ID=2. It is further configured that LCH ID=1 is linked with the CG index b, which is configured on cell b. Additionally, LCH ID=2 is linked with CG index c, which is configured on cell c.

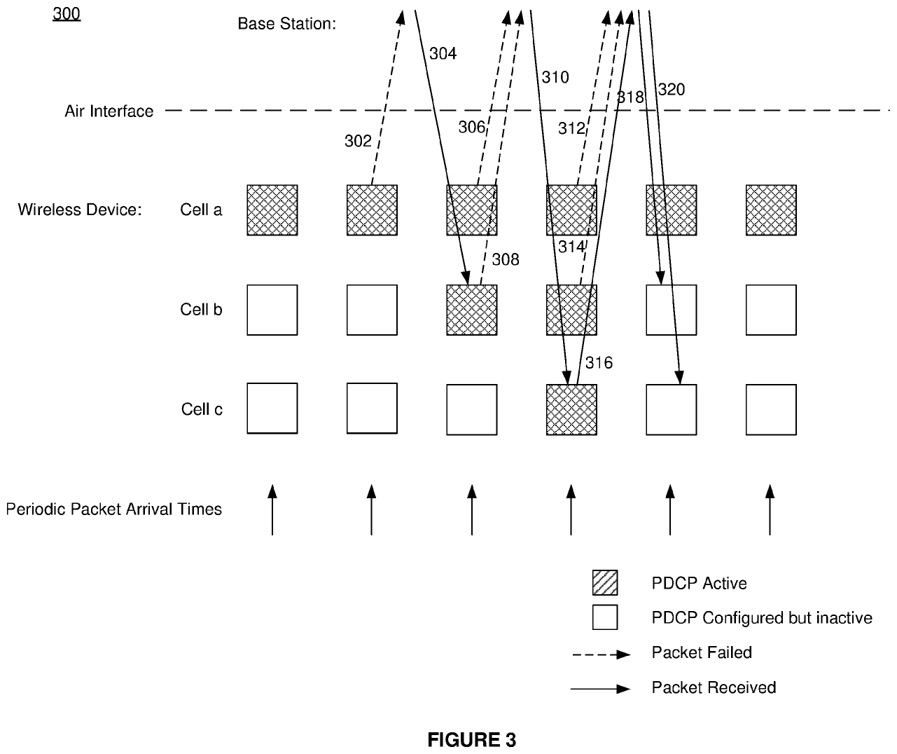

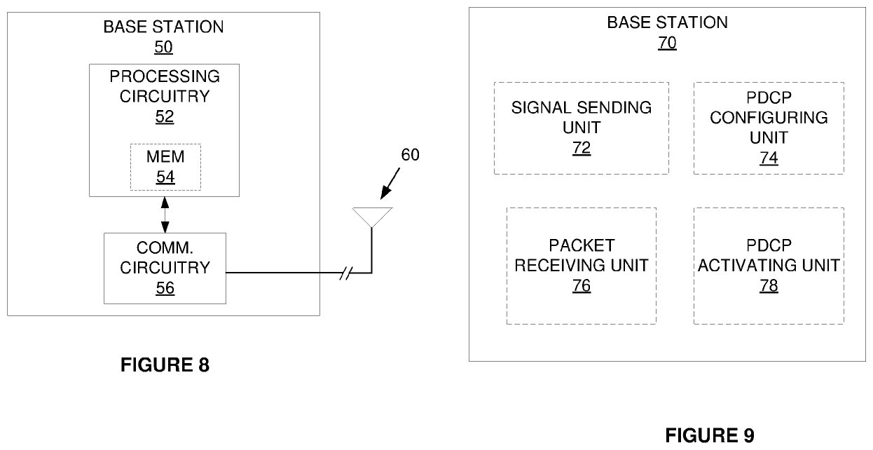

FIG. 3 depicts an example 300 of an incremental usage of PDCP configured secondary RLC entities for survival time, assuming the configuration of FIG. 8. In this example, the survival time is twice the traffic periodicity.

Initially, PDCP duplication is configured, but not activated, for LCH ID 1 and LCH ID 2, and there is no PDCP duplication transmission from the Cell b or Cell c.

At step 302, a periodic transmission on the primary RLC entity from the wireless device, on Cell a, fails (as indicated by the dashed line). In response, at step 304, the base station (e.g., gNB) transmits a CG type 2 activation command for CG b, which is configured on Cell b. The DCI command activates PDCP duplication for the secondary RLC entity with LCH ID=1 on Cell b.

At steps 306 and 308, the wireless device transmits duplicated packets on both Cell a and Cell b-however, both transmissions from Cell a and Cell b fail. In response, at step 310, the base station transmits a CG type 2 activation command for CG c, which is configured on Cell c. The DCI command activates PDCP duplication for the secondary RLC entity with LCH ID=2 on Cell c.

At steps 312, 314, and 316, the wireless device transmits duplicated packets on Cell a, Cell b and Cell c, respectively. Only the PDCP duplication transmission from Cell c is successfully received. Since a packet was received within the survival time, the base station releases the additional PDCP resources by transmitting, at steps 318 and 320, CG type 2 deactivation commands on Cell b and Cell c. This DCI command also deactivates PDCP duplication for the secondary RLC entities with LCH ID=2 and 3.

In this manner, the base station can incrementally add resources to a TSC QoS flow to meet survival time, and then release the resources once a packet is received within its PDB.

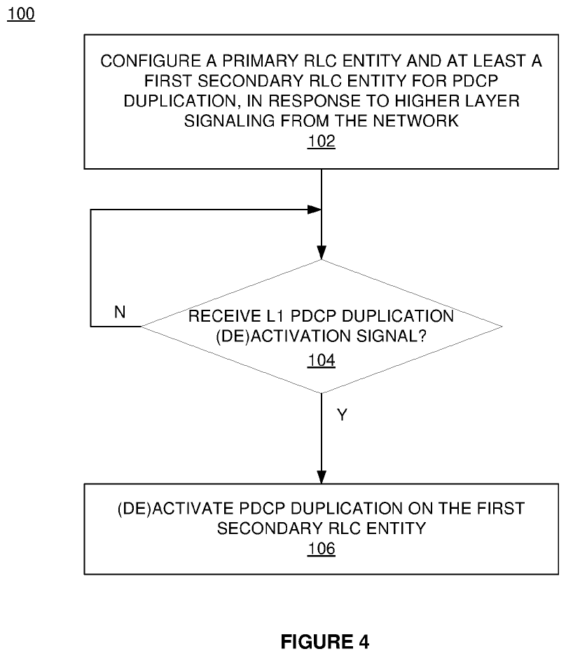

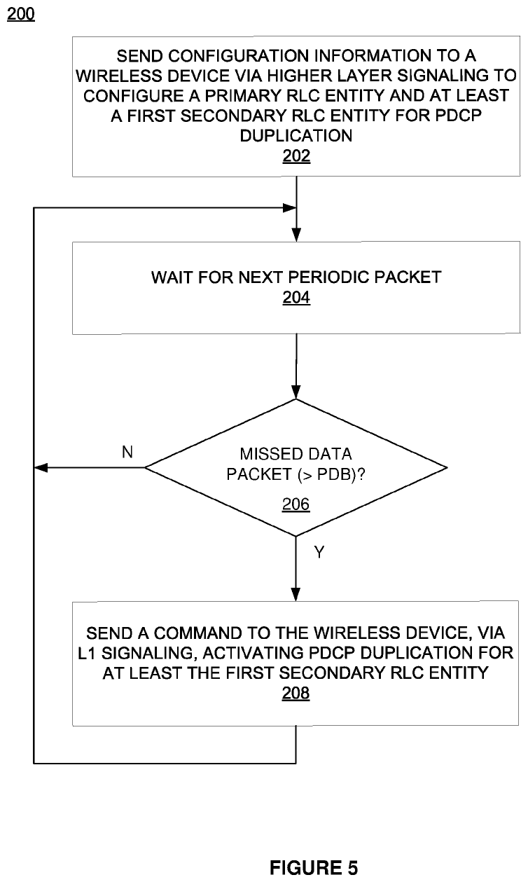

FIG. 4 depicts a method 100 in accordance with particular aspects. The method 100 is performed by a wireless device operative in a wireless communication network. The method 100 is a method of transmitting uplink data packets using Packet Data Convergence Protocol (PDCP) packet duplication. In some aspects, the uplink data packets are transmitted in a Time Sensitive Communication (TSC) Quality of Service (QOS) flow. A primary Radio Link Control (RLC) entity and at least a first secondary RLC entity are configured for PDCP duplication in response to higher layer signaling from the network (block 102). A Layer-1 (L1) signal is received from the network, requesting one of activation or deactivation of PDCP duplication on the first secondary RLC entity (block 104). In response to the L1 signal, PDCP duplication is activated or deactivated, respectively, on the first secondary RLC entity (block 106). A layer-1 (L1) signal may alternatively be termed a Level-1 (L1) signal.

FIG. 4 depicts a method 200 in accordance with other particular aspects. The method 200 is performed by a base station operative in a wireless communication network. The method 200 is a method of receiving uplink data packets using Packet Data Convergence Protocol (PDCP) packet duplication. In some aspects, the uplink data packets are received in a Time Sensitive Communication (TSC) Quality of Service (QOS) flow. Configuration information is sent to a wireless device, via higher layer signaling, to configure a primary Radio Link Control (RLC) entity and at least a first secondary RLC entity for PDCP duplication (block 202). The base station waits for the arrival time of each periodic packet in the TSC QoS flow (block 204). In response to failing to receive a periodic packet from the primary RLC entity within a predetermined Packet Delay Budget (PDB) after the packet arrival time (block 206), a command is sent to the wireless device, via L1 signaling, activating PDCP duplication for at least the first secondary RLC entity (block 208).

Note that apparatuses described herein may perform the methods 100, 200 herein and any other processing by implementing any functional means, modules, units, or circuitry. In one aspect, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several aspects. In aspects that employ memory, the memory stores program code that, when executed by the one or more processors, carries out the techniques described herein.

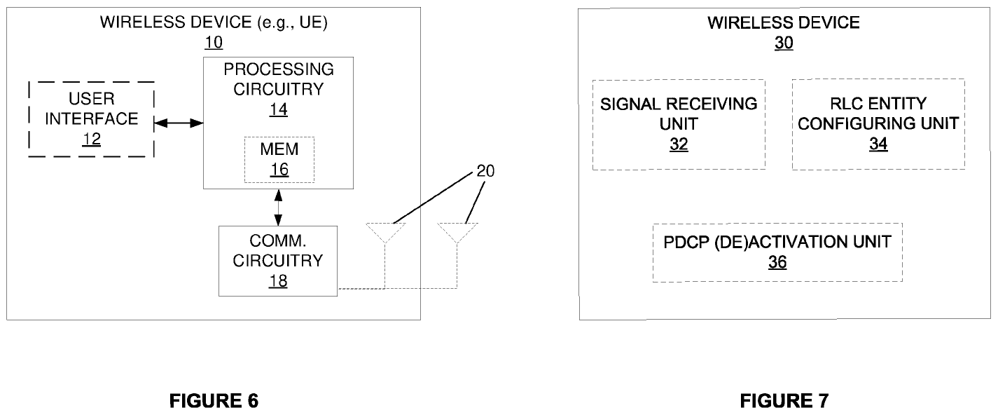

FIG. 6 for example illustrates a hardware block diagram of a wireless device 10 as implemented in accordance with one or more aspects. A wireless device 10 is any type of device capable of communicating with a network node and/or access point using radio signals. A wireless device 10 may therefore refer to a machine-to-machine (M2M) device, a machine-type communications (MTC) device, a Narrowband Internet of Things (NB IoT) device, etc. The wireless device may also be referred to as a User Equipment (UE), such as a cellular telephone or “smartphone,” however, the term UE should be understood to encompass any wireless device 10. A wireless device 10 may also be referred to as a radio device, a radio communication device, a wireless device, a wireless terminal, or simply a terminal-unless the context indicates otherwise, the use of any of these terms is intended to include device-to-device UEs or devices, machine-type devices, or devices capable of machine-to-machine communication, sensors equipped with a wireless device, wireless-enabled table computers, mobile terminals, smart phones, laptop-embedded equipped (LEE), laptop-mounted equipment (LME), USB dongles, wireless customer-premises equipment (CPE), etc. In the discussion herein, the terms machine-to-machine (M2M) device, machine-type communication (MTC) device, wireless sensor, and sensor may also be used. It should be understood that these devices, although referred to as UEs, but may be configured to transmit and/or receive data without direct human interaction.

In some aspects, the wireless device 10 includes a user interface 12 (display, touchscreen, keyboard or keypad, microphone, speaker, and the like); in other aspects, such as in many M2M, MTC, or NB IoT scenarios, the wireless device 10 may include only a minimal, or no, user interface 12 (as indicated by the dashed lines of block 12 in FIG. 4). The wireless device 10 also includes processing circuitry 14; memory 16; and communication circuitry 18 connected to one or more antennas 20, to effect wireless communication across an air interface to one or more radio network nodes, such as a base station, and/or access points. As indicated by the dashed lines, the antenna(s) 20 may protrude externally from the wireless device 10, or the antenna(s) 20 may be internal. In some aspects, a wireless device 10 may include a sophisticated user interface 12, and may additionally include features such as a camera, accelerometer, satellite navigation signal receiver circuitry, vibrating motor, and the like (not depicted in FIG. 4).

According to aspects of the present invention, the memory 16 is operative to store, and the processing circuitry 14 operative to execute, software which when executed is operative to cause the wireless device 10 to activate or de-activate PDCP duplication for one or more secondary RLC entities in response to L1 signaling, when the secondary RLC entities have been configured for PCDP operation by higher layer signaling. In particular, the software, when executed on the processing circuitry 14, is operative to perform the method 100 described and claimed herein. The processing circuitry 14 in this regard may implement certain functional means, units, or modules.

FIG. 7 illustrates a functional block diagram of a wireless device 30 in a wireless network according to still other aspects. As shown, the wireless device 30 implements various functional means, units, or modules, e.g., via the processing circuitry 14 in FIG. 6 and/or via software code. These functional means, units, or modules, e.g., for implementing the method(s) herein, include for instance: a signal receiving unit 32, a PDCP configuring unit 34, and a PDCP (de)activation unit 36.

The signal receiving unit 32 is configured to receive a PDCP configuration for one or more secondary RLC entities from the network in higher layer signaling. In response, the PDCP configuring unit 34 is configured to configure the secondary RLC entities for PDCP operation. The receiving unit 32 is further configured to receive L1 signaling activating or deactivating one or more of the secondary RLC entities. In response, the PDCP (de)activating unit 36 is configured to activate or deactivate, respectively, the identified secondary RLC entities.

FIG. 8 depicts a hardware block diagram of a base station 50 operative in a wireless communication network. The base station 50 includes processing circuitry 52; memory 54; and communication circuitry 56 connected to one or more antennas 60, to effect wireless communication across an air interface to one or more wireless devices 10. As indicated by the broken connection to the antenna(s) 60, the antenna(s) 60 may be physically located separately from the base station 50, such as mounted on a tower, building, or the like. Although the memory 56 is depicted as being internal to the processing circuitry 54, those of skill in the art understand that the memory 56 may also be external. Those of skill in the art additionally understand that virtualization techniques allow some functions nominally executed by the processing circuitry 54 to actually be executed by other hardware, perhaps remotely located (e.g., in the so-called “cloud”). The base station 50 is known in LTE as an eNodeB or eNB, and in New Radio (NR) as gNB. In general, in other wireless communication networks, the base station 50 may be known as a Radio Base Station, Base Transceiver Station, Access Point, or the like.

According to one aspect of the present invention, the processing circuitry 54 is operative to cause the base station 50 to send a PDCP activation command to a wireless device, via L1 signaling, in response to failing to receive a periodic packet within a PDB. In particular, the processing circuitry 54 is operative to perform the method 200 described and claimed herein. The processing circuitry 54 in this regard may implement certain functional means, units, or modules.

FIG. 9 illustrates a functional block diagram of a base station 70 in a wireless network according to still other aspects. As shown, the base station 72 implements various functional means, units, or modules, e.g., via the processing circuitry 52 in FIG. 8 and/or via software code. These functional means, units, or modules, e.g., for implementing the method 200 herein, include for instance: signal sending unit 72, PDCP configuring unit 74, packet receiving unit 76, and PDCP activating unit 78.

The PDCP configuring unit 74 is configured to generate information to configure a primary RLC entity and at least a first secondary RLC entity for PDCP duplication. The signal sending unit 72 is configured to send to a wireless device, via higher layer signaling, the PDCP configuration information. The packet receiving unit 76 is configured to receive periodic packets on the TSC QoS flow. The PDCP activating unit 78 is configured to activate PDCP duplication for at least the first secondary RLC entity, in response to failing to receive a periodic packet from the primary RLC entity within a predetermined PDB after the packet arrival time. The signal sending unit 72 is further configured to send to the wireless device, via L1 signaling, a PDCP activation command.

Those skilled in the art will also appreciate that aspects herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Aspects further include a carrier containing such a computer program. This carrier may comprise one of an electronic signal, optical signal, radio signal, or computer readable storage medium.

In this regard, aspects herein also include a computer program product stored on a non-transitory computer readable (storage or recording) medium and comprising instructions that, when executed by a processor of an apparatus, cause the apparatus to perform as described above.

Aspects further include a computer program product comprising program code portions for performing the steps of any of the aspects herein when the computer program product is executed by a computing device. This computer program product may be stored on a computer readable recording medium.

### Network Description and Over the Top Embodiments

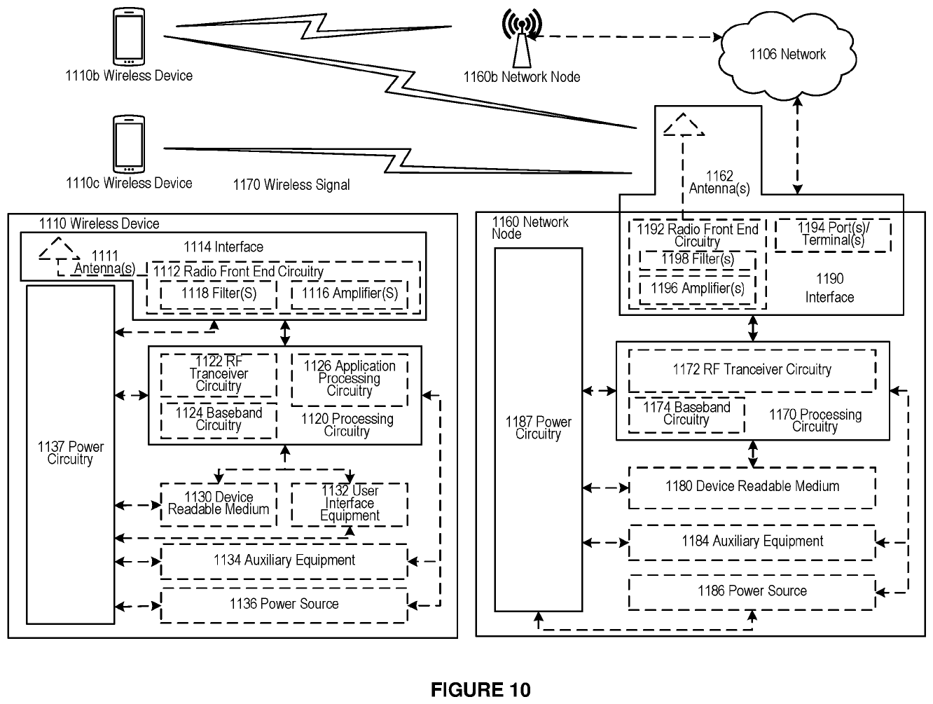

Although the subject matter described herein may be implemented in any appropriate type of system using any suitable components, the aspects disclosed herein are described in relation to a wireless network, such as the example wireless network illustrated in FIG. 10. For simplicity, the wireless network of FIG. 10 only depicts network 1106, network nodes 1160 and 1160b, and wireless devices (WD) 1110, 1110b, and 1110c. In practice, a wireless network may further include any additional elements suitable to support communication between wireless devices or between a wireless device and another communication device, such as a landline telephone, a service provider, or any other network node or end device. Of the illustrated components, network node 1160 and WD 1110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some aspects, the wireless network may be configured to operate according to specific standards or other types of predefined rules or procedures. Thus, particular aspects of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1160 and WD 1110 comprise various components described in more detail below. These components work together in order to provide network node and/or wireless device functionality, such as providing wireless connections in a wireless network. In different aspects, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 10, network node 1160 includes processing circuitry 1170, device readable medium 1180, interface 1190, auxiliary equipment 1184, power source 1186, power circuitry 1187, and antenna 1162. Although network node 1160 illustrated in the example wireless network of FIG. 10 may represent a device that includes the illustrated combination of hardware components, other aspects may comprise network nodes with different combinations of components. It is to be understood that a network node comprises any suitable combination of hardware and/or software needed to perform the tasks, features, functions and methods disclosed herein. Moreover, while the components of network node 1160 are depicted as single boxes located within a larger box, or nested within multiple boxes, in practice, a network node may comprise multiple different physical components that make up a single illustrated component (e.g., device readable medium 1180 may comprise multiple separate hard drives as well as multiple RAM modules).

Similarly, network node 1160 may be composed of multiple physically separate components (e.g., a NodeB component and a RNC component, or a BTS component and a BSC component, etc.), which may each have their own respective components. In certain scenarios in which network node 1160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some aspects, network node 1160 may be configured to support multiple radio access technologies (RATs). In such aspects, some components may be duplicated (e.g., separate device readable medium 1180 for the different RATs) and some components may be reused (e.g., the same antenna 1162 may be shared by the RATs). Network node 1160 may also include multiple sets of the various illustrated components for different wireless technologies integrated into network node 1160, such as, for example, GSM, WCDMA, LTE, NR, WiFi, or Bluetooth wireless technologies. These wireless technologies may be integrated into the same or different chip or set of chips and other components within network node 1160.

Processing circuitry 1170 is configured to perform any determining, calculating, or similar operations (e.g., certain obtaining operations) described herein as being provided by a network node. These operations performed by processing circuitry 1170 may include processing information obtained by processing circuitry 1170 by, for example, converting the obtained information into other information, comparing the obtained information or converted information to information stored in the network node, and/or performing one or more operations based on the obtained information or converted information, and as a result of said processing making a determination.

Processing circuitry 1170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1160 components, such as device readable medium 1180, network node 1160 functionality. For example, processing circuitry 1170 may execute instructions stored in device readable medium 1180 or in memory within processing circuitry 1170. Such functionality may include providing any of the various wireless features, functions, or benefits discussed herein. In some aspects, processing circuitry 1170 may include a system on a chip (SOC).

In some aspects, processing circuitry 1170 may include one or more of radio frequency (RF) transceiver circuitry 1172 and baseband processing circuitry 1174. In some aspects, radio frequency (RF) transceiver circuitry 1172 and baseband processing circuitry 1174 may be on separate chips (or sets of chips), boards, or units, such as radio units and digital units. In alternative aspects, part or all of RF transceiver circuitry 1172 and baseband processing circuitry 1174 may be on the same chip or set of chips, boards, or units

In certain aspects, some or all of the functionality described herein as being provided by a network node, base station, eNB or other such network device may be performed by processing circuitry 1170 executing instructions stored on device readable medium 1180 or memory within processing circuitry 1170. In alternative aspects, some or all of the functionality may be provided by processing circuitry 1170 without executing instructions stored on a separate or discrete device readable medium, such as in a hard-wired manner. In any of those aspects, whether executing instructions stored on a device readable storage medium or not, processing circuitry 1170 can be configured to perform the described functionality. The benefits provided by such functionality are not limited to processing circuitry 1170 alone or to other components of network node 1160, but are enjoyed by network node 1160 as a whole, and/or by end users and the wireless network generally.

Device readable medium 1180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1170. Device readable medium 1180 may store any suitable instructions, data or information, including a computer program, software, an application including one or more of logic, rules, code, tables, etc. and/or other instructions capable of being executed by processing circuitry 1170 and, utilized by network node 1160. Device readable medium 1180 may be used to store any calculations made by processing circuitry 1170 and/or any data received via interface 1190. In some aspects, processing circuitry 1170 and device readable medium 1180 may be considered to be integrated.

Interface 1190 is used in the wired or wireless communication of signaling and/or data between network node 1160, network 1106, and/or WDs 1110. As illustrated, interface 1190 comprises port(s)/terminal(s) 1194 to send and receive data, for example to and from network 1106 over a wired connection. Interface 1190 also includes radio front end circuitry 1192 that may be coupled to, or in certain aspects a part of, antenna 1162. Radio front end circuitry 1192 comprises filters 1198 and amplifiers 1196. Radio front end circuitry 1192 may be connected to antenna 1162 and processing circuitry 1170. Radio front end circuitry may be configured to condition signals communicated between antenna 1162 and processing circuitry 1170. Radio front end circuitry 1192 may receive digital data that is to be sent out to other network nodes or WDs via a wireless connection. Radio front end circuitry 1192 may convert the digital data into a radio signal having the appropriate channel and bandwidth parameters using a combination of filters 1198 and/or amplifiers 1196. The radio signal may then be transmitted via antenna 1162. Similarly, when receiving data, antenna 1162 may collect radio signals which are then converted into digital data by radio front end circuitry 1192. The digital data may be passed to processing circuitry 1170. In other aspects, the interface may comprise different components and/or different combinations of components.

In certain alternative aspects, network node 1160 may not include separate radio front end circuitry 1192, instead, processing circuitry 1170 may comprise radio front end circuitry and may be connected to antenna 1162 without separate radio front end circuitry 1192. Similarly, in some aspects, all or some of RF transceiver circuitry 1172 may be considered a part of interface 1190. In still other aspects, interface 1190 may include one or more ports or terminals 1194, radio front end circuitry 1192, and RF transceiver circuitry 1172, as part of a radio unit (not shown), and interface 1190 may communicate with baseband processing circuitry 1174, which is part of a digital unit (not shown).

Antenna 1162 may include one or more antennas, or antenna arrays, configured to send and/or receive wireless signals. Antenna 1162 may be coupled to radio front end circuitry 1190 and may be any type of antenna capable of transmitting and receiving data and/or signals wirelessly. In some aspects, antenna 1162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain aspects, antenna 1162 may be separate from network node 1160 and may be connectable to network node 1160 through an interface or port.

Antenna 1162, interface 1190, and/or processing circuitry 1170 may be configured to perform any receiving operations and/or certain obtaining operations described herein as being performed by a network node. Any information, data and/or signals may be received from a wireless device, another network node and/or any other network equipment. Similarly, antenna 1162, interface 1190, and/or processing circuitry 1170 may be configured to perform any transmitting operations described herein as being performed by a network node. Any information, data and/or signals may be transmitted to a wireless device, another network node and/or any other network equipment.

Power circuitry 1187 may comprise, or be coupled to, power management circuitry and is configured to supply the components of network node 1160 with power for performing the functionality described herein. Power circuitry 1187 may receive power from power source 1186. Power source 1186 and/or power circuitry 1187 may be configured to provide power to the various components of network node 1160 in a form suitable for the respective components (e.g., at a voltage and current level needed for each respective component). Power source 1186 may either be included in, or external to, power circuitry 1187 and/or network node 1160. For example, network node 1160 may be connectable to an external power source (e.g., an electricity outlet) via an input circuitry or interface such as an electrical cable, whereby the external power source supplies power to power circuitry 1187. As a further example, power source 1186 may comprise a source of power in the form of a battery or battery pack which is connected to, or integrated in, power circuitry 1187. The battery may provide backup power should the external power source fail. Other types of power sources, such as photovoltaic devices, may also be used.

Alternative aspects of network node 1160 may include additional components beyond those shown in FIG. 10 that may be responsible for providing certain aspects of the network node's functionality, including any of the functionality described herein and/or any functionality necessary to support the subject matter described herein. For example, network node 1160 may include user interface equipment to allow input of information into network node 1160 and to allow output of information from network node 1160. This may allow a user to perform diagnostic, maintenance, repair, and other administrative functions for network node 1160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some aspects, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1110 includes antenna 1111, interface 1114, processing circuitry 1120, device readable medium 1130, user interface equipment 1132, auxiliary equipment 1134, power source 1136 and power circuitry 1137. WD 1110 may include multiple sets of one or more of the illustrated components for different wireless technologies supported by WD 1110, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1110.

Antenna 1111 may include one or more antennas or antenna arrays, configured to send and/or receive wireless signals, and is connected to interface 1114. In certain alternative aspects, antenna 1111 may be separate from WD 1110 and be connectable to WD 1110 through an interface or port. Antenna 1111, interface 1114, and/or processing circuitry 1120 may be configured to perform any receiving or transmitting operations described herein as being performed by a WD. Any information, data and/or signals may be received from a network node and/or another WD. In some aspects, radio front end circuitry and/or antenna 1111 may be considered an interface.

As illustrated, interface 1114 comprises radio front end circuitry 1112 and antenna 1111. Radio front end circuitry 1112 comprise one or more filters 1118 and amplifiers 1116. Radio front end circuitry 1114 is connected to antenna 1111 and processing circuitry 1120, and is configured to condition signals communicated between antenna 1111 and processing circuitry 1120. Radio front end circuitry 1112 may be coupled to or a part of antenna 1111. In some aspects, WD 1110 may not include separate radio front end circuitry 1112; rather, processing circuitry 1120 may comprise radio front end circuitry and may be connected to antenna 1111. Similarly, in some aspects, some or all of RF transceiver circuitry 1122 may be considered a part of interface 1114. Radio front end circuitry 1112 may receive digital data that is to be sent out to other network nodes or WDs via a wireless connection. Radio front end circuitry 1112 may convert the digital data into a radio signal having the appropriate channel and bandwidth parameters using a combination of filters 1118 and/or amplifiers 1116. The radio signal may then be transmitted via antenna 1111. Similarly, when receiving data, antenna 1111 may collect radio signals which are then converted into digital data by radio front end circuitry 1112. The digital data may be passed to processing circuitry 1120. In other aspects, the interface may comprise different components and/or different combinations of components.

Processing circuitry 1120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1110 components, such as device readable medium 1130, WD 1110 functionality. Such functionality may include providing any of the various wireless features or benefits discussed herein. For example, processing circuitry 1120 may execute instructions stored in device readable medium 1130 or in memory within processing circuitry 1120 to provide the functionality disclosed herein.

As illustrated, processing circuitry 1120 includes one or more of RF transceiver circuitry 1122, baseband processing circuitry 1124, and application processing circuitry 1126. In other aspects, the processing circuitry may comprise different components and/or different combinations of components. In certain aspects processing circuitry 1120 of WD 1110 may comprise a SOC. In some aspects, RF transceiver circuitry 1122, baseband processing circuitry 1124, and application processing circuitry 1126 may be on separate chips or sets of chips. In alternative aspects, part or all of baseband processing circuitry 1124 and application processing circuitry 1126 may be combined into one chip or set of chips, and RF transceiver circuitry 1122 may be on a separate chip or set of chips. In still alternative aspects, part or all of RF transceiver circuitry 1122 and baseband processing circuitry 1124 may be on the same chip or set of chips, and application processing circuitry 1126 may be on a separate chip or set of chips. In yet other alternative aspects, part or all of RF transceiver circuitry 1122, baseband processing circuitry 1124, and application processing circuitry 1126 may be combined in the same chip or set of chips. In some aspects, RF transceiver circuitry 1122 may be a part of interface 1114. RF transceiver circuitry 1122 may condition RF signals for processing circuitry 1120.

In certain aspects, some or all of the functionality described herein as being performed by a WD may be provided by processing circuitry 1120 executing instructions stored on device readable medium 1130, which in certain aspects may be a computer-readable storage medium. In alternative aspects, some or all of the functionality may be provided by processing circuitry 1120 without executing instructions stored on a separate or discrete device readable storage medium, such as in a hard-wired manner. In any of those particular aspects, whether executing instructions stored on a device readable storage medium or not, processing circuitry 1120 can be configured to perform the described functionality. The benefits provided by such functionality are not limited to processing circuitry 1120 alone or to other components of WD 1110, but are enjoyed by WD 1110 as a whole, and/or by end users and the wireless network generally.

Processing circuitry 1120 may be configured to perform any determining, calculating, or similar operations (e.g., certain obtaining operations) described herein as being performed by a WD. These operations, as performed by processing circuitry 1120, may include processing information obtained by processing circuitry 1120 by, for example, converting the obtained information into other information, comparing the obtained information or converted information to information stored by WD 1110, and/or performing one or more operations based on the obtained information or converted information, and as a result of said processing making a determination.

Device readable medium 1130 may be operable to store a computer program, software, an application including one or more of logic, rules, code, tables, etc. and/or other instructions capable of being executed by processing circuitry 1120. Device readable medium 1130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1120. In some aspects, processing circuitry 1120 and device readable medium 1130 may be considered to be integrated.

User interface equipment 1132 may provide components that allow for a human user to interact with WD 1110. Such interaction may be of many forms, such as visual, audial, tactile, etc. User interface equipment 1132 may be operable to produce output to the user and to allow the user to provide input to WD 1110. The type of interaction may vary depending on the type of user interface equipment 1132 installed in WD 1110. For example, if WD 1110 is a smart phone, the interaction may be via a touch screen; if WD 1110 is a smart meter, the interaction may be through a screen that provides usage (e.g., the number of gallons used) or a speaker that provides an audible alert (e.g., if smoke is detected). User interface equipment 1132 may include input interfaces, devices and circuits, and output interfaces, devices and circuits. User interface equipment 1132 is configured to allow input of information into WD 1110, and is connected to processing circuitry 1120 to allow processing circuitry 1120 to process the input information. User interface equipment 1132 may include, for example, a microphone, a proximity or other sensor, keys/buttons, a touch display, one or more cameras, a USB port, or other input circuitry. User interface equipment 1132 is also configured to allow output of information from WD 1110, and to allow processing circuitry 1120 to output information from WD 1110. User interface equipment 1132 may include, for example, a speaker, a display, vibrating circuitry, a USB port, a headphone interface, or other output circuitry. Using one or more input and output interfaces, devices, and circuits, of user interface equipment 1132, WD 1110 may communicate with end users and/or the wireless network, and allow them to benefit from the functionality described herein.

Auxiliary equipment 1134 is operable to provide more specific functionality which may not be generally performed by WDs. This may comprise specialized sensors for doing measurements for various purposes, interfaces for additional types of communication such as wired communications etc. The inclusion and type of components of auxiliary equipment 1134 may vary depending on the aspect and/or scenario.

Power source 1136 may, in some aspects, be in the form of a battery or battery pack. Other types of power sources, such as an external power source (e.g., an electricity outlet), photovoltaic devices or power cells, may also be used. WD 1110 may further comprise power circuitry 1137 for delivering power from power source 1136 to the various parts of WD 1110 which need power from power source 1136 to carry out any functionality described or indicated herein. Power circuitry 1137 may in certain aspects comprise power management circuitry. Power circuitry 1137 may additionally or alternatively be operable to receive power from an external power source; in which case WD 1110 may be connectable to the external power source (such as an electricity outlet) via input circuitry or an interface such as an electrical power cable. Power circuitry 1137 may also in certain aspects be operable to deliver power from an external power source to power source 1136. This may be, for example, for the charging of power source 1136. Power circuitry 1137 may perform any formatting, converting, or other modification to the power from power source 1136 to make the power suitable for the respective components of WD 1110 to which power is supplied.

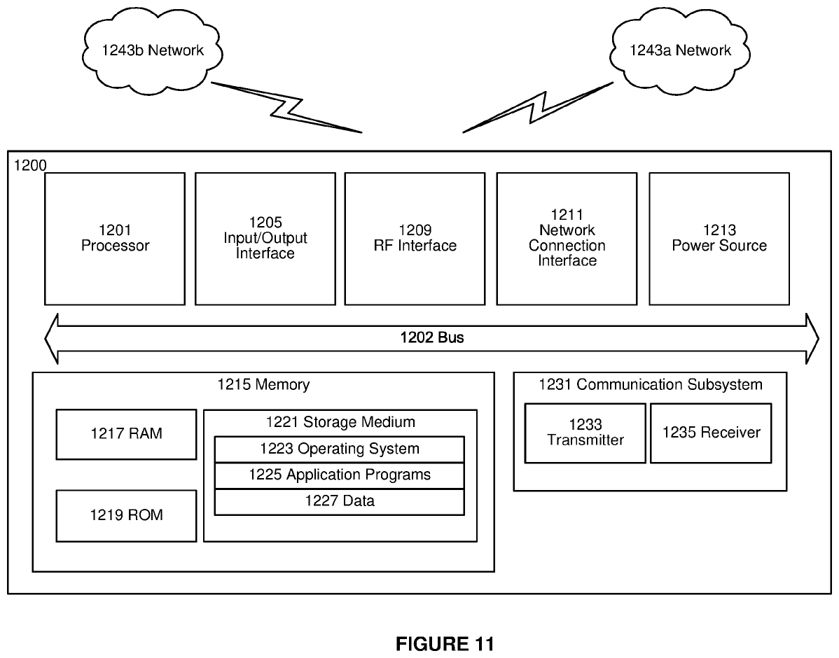

FIG. 11 illustrates one aspect of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1200 may be any UE identified by the 3^{rd} Generation Partnership Project (3GPP), including a NB-IoT UE, a machine type communication (MTC) UE, and/or an enhanced MTC (eMTC) UE. UE 1200, as illustrated in FIG. 11, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 11 is a UE, the components discussed herein are equally applicable to a WD, and vice-versa.

In FIG. 11, UE 1200 includes processing circuitry 1201 that is operatively coupled to input/output interface 1205, radio frequency (RF) interface 1209, network connection interface 1211, memory 1215 including random access memory (RAM) 1217, read-only memory (ROM) 1219, and storage medium 1221 or the like, communication subsystem 1231, power source 1233, and/or any other component, or any combination thereof. Storage medium 1221 includes operating system 1223, application program 1225, and data 1227. In other aspects, storage medium 1221 may include other similar types of information. Certain UEs may utilize all of the components shown in FIG. 11, or only a subset of the components. The level of integration between the components may vary from one UE to another UE. Further, certain UEs may contain multiple instances of a component, such as multiple processors, memories, transceivers, transmitters, receivers, etc.

In FIG. 11, processing circuitry 1201 may be configured to process computer instructions and data. Processing circuitry 1201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1201 may include two central processing units (CPUs). Data may be information in a form suitable for use by a computer.

In the depicted aspect, input/output interface 1205 may be configured to provide a communication interface to an input device, output device, or input and output device. UE 1200 may be configured to use an output device via input/output interface 1205. An output device may use the same type of interface port as an input device. For example, a USB port may be used to provide input to and output from UE 1200. The output device may be a speaker, a sound card, a video card, a display, a monitor, a printer, an actuator, an emitter, a smartcard, another output device, or any combination thereof. UE 1200 may be configured to use an input device via input/output interface 1205 to allow a user to capture information into UE 1200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 11, RF interface 1209 may be configured to provide a communication interface to RF components such as a transmitter, a receiver, and an antenna. Network connection interface 1211 may be configured to provide a communication interface to network 1243a. Network 1243a may encompass wired and/or wireless networks such as a local-area network (LAN), a wide-area network (WAN), a computer network, a wireless network, a telecommunications network, another like network or any combination thereof. For example, network 1243a may comprise a Wi-Fi network. Network connection interface 1211 may be configured to include a receiver and a transmitter interface used to communicate with one or more other devices over a communication network according to one or more communication protocols, such as Ethernet, TCP/IP, SONET, ATM, or the like. Network connection interface 1211 may implement receiver and transmitter functionality appropriate to the communication network links (e.g., optical, electrical, and the like). The transmitter and receiver functions may share circuit components, software or firmware, or alternatively may be implemented separately.

RAM 1217 may be configured to interface via bus 1202 to processing circuitry 1201 to provide storage or caching of data or computer instructions during the execution of software programs such as the operating system, application programs, and device drivers. ROM 1219 may be configured to provide computer instructions or data to processing circuitry 1201. For example, ROM 1219 may be configured to store invariant low-level system code or data for basic system functions such as basic input and output (I/O), startup, or reception of keystrokes from a keyboard that are stored in a non-volatile memory. Storage medium 1221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1221 may be configured to include operating system 1223, application program 1225 such as a web browser application, a widget or gadget engine or another application, and data file 1227. Storage medium 1221 may store, for use by UE 1200, any of a variety of various operating systems or combinations of operating systems.

Storage medium 1221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1221 may allow UE 1200 to access computer-executable instructions, application programs or the like, stored on transitory or non-transitory memory media, to off-load data, or to upload data. An article of manufacture, such as one utilizing a communication system may be tangibly embodied in storage medium 1221, which may comprise a device readable medium.

In FIG. 11, processing circuitry 1201 may be configured to communicate with network 1243b using communication subsystem 1231. Network 1243a and network 1243b may be the same network or networks or different network or networks. Communication subsystem 1231 may be configured to include one or more transceivers used to communicate with network 1243b. For example, communication subsystem 1231 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1233 and/or receiver 1235 to implement transmitter or receiver functionality, respectively, appropriate to the RAN links (e.g., frequency allocations and the like). Further, transmitter 1233 and receiver 1235 of each transceiver may share circuit components, software or firmware, or alternatively may be implemented separately.

In the illustrated aspect, the communication functions of communication subsystem 1231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1231 may include cellular communication, Wi-Fi communication, Bluetooth communication, and GPS communication. Network 1243b may encompass wired and/or wireless networks such as a local-area network (LAN), a wide-area network (WAN), a computer network, a wireless network, a telecommunications network, another like network or any combination thereof. For example, network 1243b may be a cellular network, a Wi-Fi network, and/or a near-field network. Power source 1213 may be configured to provide alternating current (AC) or direct current (DC) power to components of UE 1200.

The features, benefits and/or functions described herein may be implemented in one of the components of UE 1200 or partitioned across multiple components of UE 1200. Further, the features, benefits, and/or functions described herein may be implemented in any combination of hardware, software or firmware. In one example, communication subsystem 1231 may be configured to include any of the components described herein. Further, processing circuitry 1201 may be configured to communicate with any of such components over bus 1202. In another example, any of such components may be represented by program instructions stored in memory that when executed by processing circuitry 1201 perform the corresponding functions described herein. In another example, the functionality of any of such components may be partitioned between processing circuitry 1201 and communication subsystem 1231. In another example, the non-computationally intensive functions of any of such components may be implemented in software or firmware and the computationally intensive functions may be implemented in hardware.

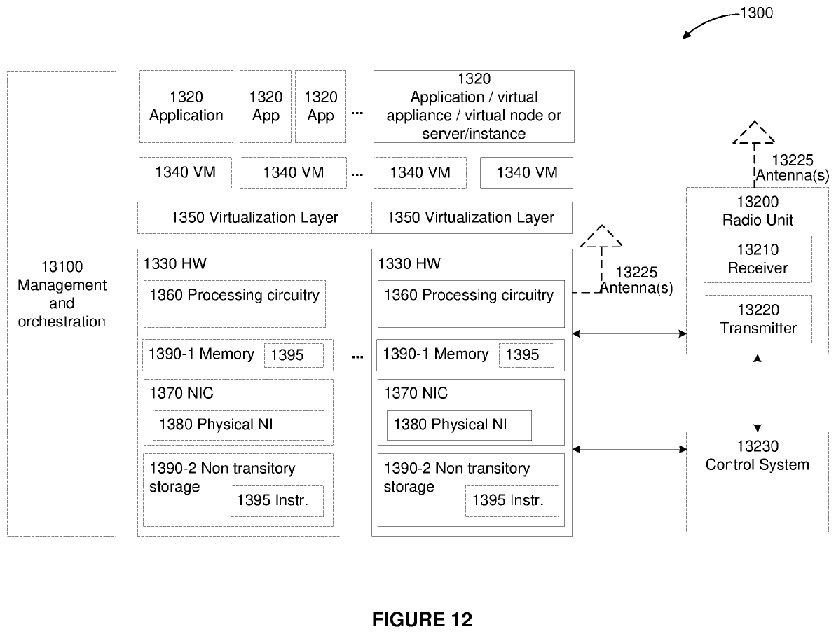

FIG. 12 is a schematic block diagram illustrating a virtualization environment 1300 in which functions implemented by some aspects may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some aspects, some or all of the functions described herein may be implemented as virtual components executed by one or more virtual machines implemented in one or more virtual environments 1300 hosted by one or more of hardware nodes 1330. Further, in aspects in which the virtual node is not a radio access node or does not require radio connectivity (e.g., a core network node), then the network node may be entirely virtualized.

The functions may be implemented by one or more applications 1320 (which may alternatively be called software instances, virtual appliances, network functions, virtual nodes, virtual network functions, etc.) operative to implement some of the features, functions, and/or benefits of some of the aspects disclosed herein. Applications 1320 are run in virtualization environment 1300 which provides hardware 1330 comprising processing circuitry 1360 and memory 1390. Memory 1390 contains instructions 1395 executable by processing circuitry 1360 whereby application 1320 is operative to provide one or more of the features, benefits, and/or functions disclosed herein.

Virtualization environment 1300, comprises general-purpose or special-purpose network hardware devices 1330 comprising a set of one or more processors or processing circuitry 1360, which may be commercial off-the-shelf (COTS) processors, dedicated Application Specific Integrated Circuits (ASICs), or any other type of processing circuitry including digital or analog hardware components or special purpose processors. Each hardware device may comprise memory 1390-1 which may be non-persistent memory for temporarily storing instructions 1395 or software executed by processing circuitry 1360. Each hardware device may comprise one or more network interface controllers (NICs) 1370, also known as network interface cards, which include physical network interface 1380. Each hardware device may also include non-transitory, persistent, machine-readable storage media 1390-2 having stored therein software 1395 and/or instructions executable by processing circuitry 1360. Software 1395 may include any type of software including software for instantiating one or more virtualization layers 1350 (also referred to as hypervisors), software to execute virtual machines 1340 as well as software allowing it to execute functions, features and/or benefits described in relation with some aspects described herein.

Virtual machines 1340, comprise virtual processing, virtual memory, virtual networking or interface and virtual storage, and may be run by a corresponding virtualization layer 1350 or hypervisor. Different aspects of the instance of virtual appliance 1320 may be implemented on one or more of virtual machines 1340, and the implementations may be made in different ways.

During operation, processing circuitry 1360 executes software 1395 to instantiate the hypervisor or virtualization layer 1350, which may sometimes be referred to as a virtual machine monitor (VMM). Virtualization layer 1350 may present a virtual operating platform that appears like networking hardware to virtual machine 1340.

As shown in FIG. 12, hardware 1330 may be a standalone network node with generic or specific components. Hardware 1330 may comprise antenna 13225 and may implement some functions via virtualization. Alternatively, hardware 1330 may be part of a larger cluster of hardware (e.g., such as in a data center or customer premise equipment (CPE)) where many hardware nodes work together and are managed via management and orchestration (MANO) 13100, which, among others, oversees lifecycle management of applications 1320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1340 may be a software implementation of a physical machine that runs programs as if they were executing on a physical, non-virtualized machine. Each of virtual machines 1340, and that part of hardware 1330 that executes that virtual machine, be it hardware dedicated to that virtual machine and/or hardware shared by that virtual machine with others of the virtual machines 1340, forms a separate virtual network elements (VNE).

Still in the context of NFV, Virtual Network Function (VNF) is responsible for handling specific network functions that run in one or more virtual machines 1340 on top of hardware networking infrastructure 1330 and corresponds to application 1320 in FIG. 12.

In some aspects, one or more radio units 13200 that each include one or more transmitters 13220 and one or more receivers 13210 may be coupled to one or more antennas 13225. Radio units 13200 may communicate directly with hardware nodes 1330 via one or more appropriate network interfaces and may be used in combination with the virtual components to provide a virtual node with radio capabilities, such as a radio access node or a base station.

In some aspects, some signaling can be effected with the use of control system 13230 which may alternatively be used for communication between the hardware nodes 1330 and radio units 13200.

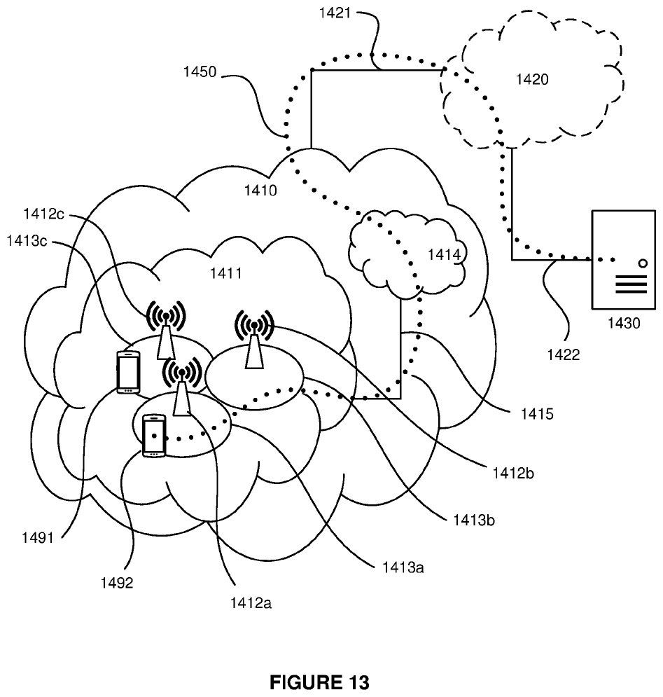

FIG. 13 illustrates a telecommunication network connected via an intermediate network to a host computer in accordance with some aspects. In particular, with reference to FIG. 13, in accordance with an aspect, a communication system includes telecommunication network 1410, such as a 3GPP-type cellular network, which comprises access network 1411, such as a radio access network, and core network 1414. Access network 1411 comprises a plurality of base stations 1412a, 1412b, 1412c, such as NBs, eNBs, gNBs or other types of wireless access points, each defining a corresponding coverage area 1413a, 1413b, 1413c. Each base station 1412a, 1412b, 1412c is connectable to core network 1414 over a wired or wireless connection 1415. A first UE 1491 located in coverage area 1413c is configured to wirelessly connect to, or be paged by, the corresponding base station 1412c. A second UE 1492 in coverage area 1413a is wirelessly connectable to the corresponding base station 1412a. While a plurality of UEs 1491, 1492 are illustrated in this example, the disclosed aspects are equally applicable to a situation where a sole UE is in the coverage area or where a sole UE is connecting to the corresponding base station 1412.

Telecommunication network 1410 is itself connected to host computer 1430, which may be embodied in the hardware and/or software of a standalone server, a cloud-implemented server, a distributed server or as processing resources in a server farm. Host computer 1430 may be under the ownership or control of a service provider, or may be operated by the service provider or on behalf of the service provider. Connections 1421 and 1422 between telecommunication network 1410 and host computer 1430 may extend directly from core network 1414 to host computer 1430 or may go via an optional intermediate network 1420. Intermediate network 1420 may be one of, or a combination of more than one of, a public, private or hosted network; intermediate network 1420, if any, may be a backbone network or the Internet; in particular, intermediate network 1420 may comprise two or more sub-networks (not shown).

The communication system of FIG. 13 as a whole enables connectivity between the connected UEs 1491, 1492 and host computer 1430. The connectivity may be described as an over-the-top (OTT) connection 1450. Host computer 1430 and the connected UEs 1491, 1492 are configured to communicate data and/or signaling via OTT connection 1450, using access network 1411, core network 1414, any intermediate network 1420 and possible further infrastructure (not shown) as intermediaries. OTT connection 1450 may be transparent in the sense that the participating communication devices through which OTT connection 1450 passes are unaware of routing of uplink and downlink communications. For example, base station 1412 may not or need not be informed about the past routing of an incoming downlink communication with data originating from host computer 1430 to be forwarded (e.g., handed over) to a connected UE 1491. Similarly, base station 1412 need not be aware of the future routing of an outgoing uplink communication originating from the UE 1491 towards the host computer 1430.

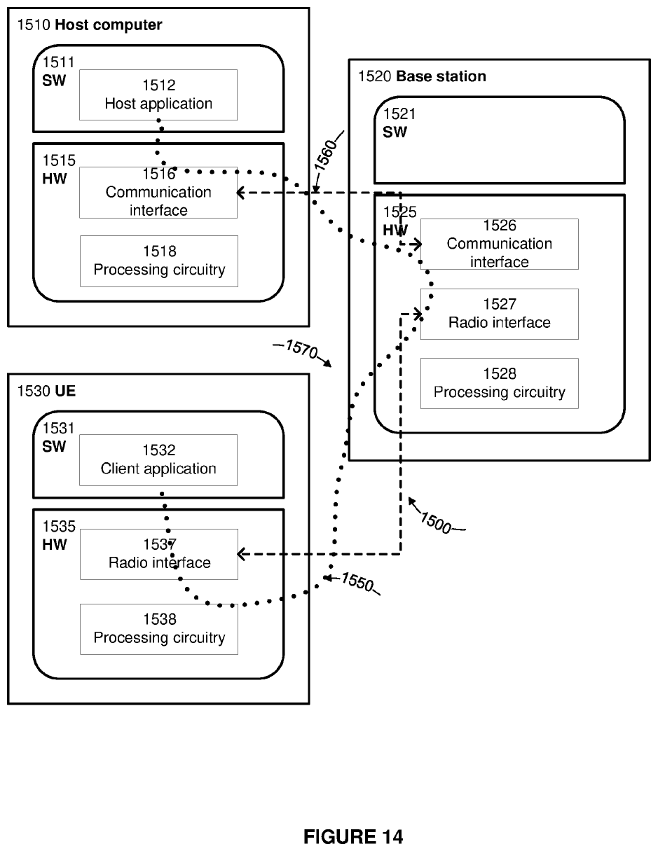

Example implementations, in accordance with an aspect, of the UE, base station and host computer discussed in the preceding paragraphs will now be described with reference to FIG. 14. FIG. 14 illustrates host computer communicating via a base station with a user equipment over a partially wireless connection in accordance with some aspects. In communication system 1500, host computer 1510 comprises hardware 1515 including communication interface 1516 configured to set up and maintain a wired or wireless connection with an interface of a different communication device of communication system 1500. Host computer 1510 further comprises processing circuitry 1518, which may have storage and/or processing capabilities. In particular, processing circuitry 1518 may comprise one or more programmable processors, application-specific integrated circuits, field programmable gate arrays or combinations of these (not shown) adapted to execute instructions. Host computer 1510 further comprises software 1511, which is stored in or accessible by host computer 1510 and executable by processing circuitry 1518. Software 1511 includes host application 1512. Host application 1512 may be operable to provide a service to a remote user, such as UE 1530 connecting via OTT connection 1550 terminating at UE 1530 and host computer 1510. In providing the service to the remote user, host application 1512 may provide user data which is transmitted using OTT connection 1550.

Communication system 1500 further includes base station 1520 provided in a telecommunication system and comprising hardware 1525 enabling it to communicate with host computer 1510 and with UE 1530. Hardware 1525 may include communication interface 1526 for setting up and maintaining a wired or wireless connection with an interface of a different communication device of communication system 1500, as well as radio interface 1527 for setting up and maintaining at least wireless connection 1570 with UE 1530 located in a coverage area (not shown in FIG. 14) served by base station 1520. Communication interface 1526 may be configured to facilitate connection 1560 to host computer 1510. Connection 1560 may be direct, or it may pass through a core network (not shown in FIG. 14) of the telecommunication system and/or through one or more intermediate networks outside the telecommunication system. In the aspect shown, hardware 1525 of base station 1520 further includes processing circuitry 1528, which may comprise one or more programmable processors, application-specific integrated circuits, field programmable gate arrays or combinations of these (not shown) adapted to execute instructions. Base station 1520 further has software 1521 stored internally or accessible via an external connection.

Communication system 1500 further includes UE 1530 already referred to. Its hardware 1535 may include radio interface 1537 configured to set up and maintain wireless connection 1570 with a base station serving a coverage area in which UE 1530 is currently located. Hardware 1535 of UE 1530 further includes processing circuitry 1538, which may comprise one or more programmable processors, application-specific integrated circuits, field programmable gate arrays or combinations of these (not shown) adapted to execute instructions. UE 1530 further comprises software 1531, which is stored in or accessible by UE 1530 and executable by processing circuitry 1538. Software 1531 includes client application 1532. Client application 1532 may be operable to provide a service to a human or non-human user via UE 1530, with the support of host computer 1510. In host computer 1510, an executing host application 1512 may communicate with the executing client application 1532 via OTT connection 1550 terminating at UE 1530 and host computer 1510. In providing the service to the user, client application 1532 may receive request data from host application 1512 and provide user data in response to the request data. OTT connection 1550 may transfer both the request data and the user data. Client application 1532 may interact with the user to generate the user data that it provides.

It is noted that host computer 1510, base station 1520 and UE 1530 illustrated in FIG. 14 may be similar or identical to host computer 1430, one of base stations 1412a, 1412b, 1412c and one of UEs 1491, 1492 of FIG. 13, respectively. This is to say, the inner workings of these entities may be as shown in FIG. 14 and independently, the surrounding network topology may be that of FIG. 13.

In FIG. 14, OTT connection 1550 has been drawn abstractly to illustrate the communication between host computer 1510 and UE 1530 via base station 1520, without explicit reference to any intermediary devices and the precise routing of messages via these devices. Network infrastructure may determine the routing, which it may be configured to hide from UE 1530 or from the service provider operating host computer 1510, or both. While OTT connection 1550 is active, the network infrastructure may further take decisions by which it dynamically changes the routing (e.g., on the basis of load balancing consideration or reconfiguration of the network).

Wireless connection 1570 between UE 1530 and base station 1520 is in accordance with the teachings of the aspects described throughout this disclosure. One or more of the various aspects improve the performance of OTT services provided to UE 1530 using OTT connection 1550, in which wireless connection 1570 forms the last segment. More precisely, the teachings of these aspects may improve the latency and thereby provide benefits such as the ability to meet the requirements of TSC QoS flows.

A measurement procedure may be provided for the purpose of monitoring data rate, latency and other factors on which the one or more aspects improve. There may further be an optional network functionality for reconfiguring OTT connection 1550 between host computer 1510 and UE 1530, in response to variations in the measurement results. The measurement procedure and/or the network functionality for reconfiguring OTT connection 1550 may be implemented in software 1511 and hardware 1515 of host computer 1510 or in software 1531 and hardware 1535 of UE 1530, or both. In aspects, sensors (not shown) may be deployed in or in association with communication devices through which OTT connection 1550 passes; the sensors may participate in the measurement procedure by supplying values of the monitored quantities exemplified above, or supplying values of other physical quantities from which software 1511, 1531 may compute or estimate the monitored quantities. The reconfiguring of OTT connection 1550 may include message format, retransmission settings, preferred routing etc.; the reconfiguring need not affect base station 1520, and it may be unknown or imperceptible to base station 1520. Such procedures and functionalities may be known and practiced in the art. In certain aspects, measurements may involve proprietary UE signaling facilitating host computer 1510's measurements of throughput, propagation times, latency and the like. The measurements may be implemented in that software 1511 and 1531 causes messages to be transmitted, in particular empty or ‘dummy’ messages, using OTT connection 1550 while it monitors propagation times, errors etc.

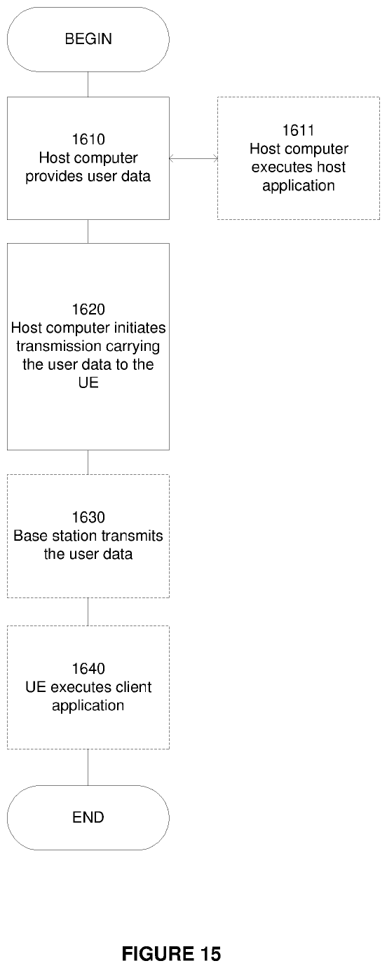

FIG. 15 is a flowchart illustrating a method implemented in a communication system, in accordance with one aspect. The communication system includes a host computer, a base station and a UE which may be those described with reference to FIG. 13 and FIG. 14. For simplicity of the present disclosure, only drawing references to FIG. 15 will be included in this section. In step 1610, the host computer provides user data. In substep 1611 (which may be optional) of step 1610, the host computer provides the user data by executing a host application. In step 1620, the host computer initiates a transmission carrying the user data to the UE. In step 1630 (which may be optional), the base station transmits to the UE the user data which was carried in the transmission that the host computer initiated, in accordance with the teachings of the aspects described throughout this disclosure. In step 1640 (which may also be optional), the UE executes a client application associated with the host application executed by the host computer.

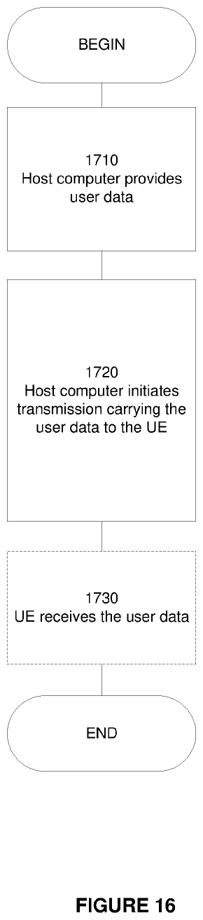

FIG. 16 is a flowchart illustrating a method implemented in a communication system, in accordance with one aspect. The communication system includes a host computer, a base station and a UE which may be those described with reference to FIG. 13 and FIG. 14. For simplicity of the present disclosure, only drawing references to FIG. 16 will be included in this section. In step 1710 of the method, the host computer provides user data. In an optional substep (not shown) the host computer provides the user data by executing a host application. In step 1720, the host computer initiates a transmission carrying the user data to the UE. The transmission may pass via the base station, in accordance with the teachings of the aspects described throughout this disclosure. In step 1730 (which may be optional), the UE receives the user data carried in the transmission.

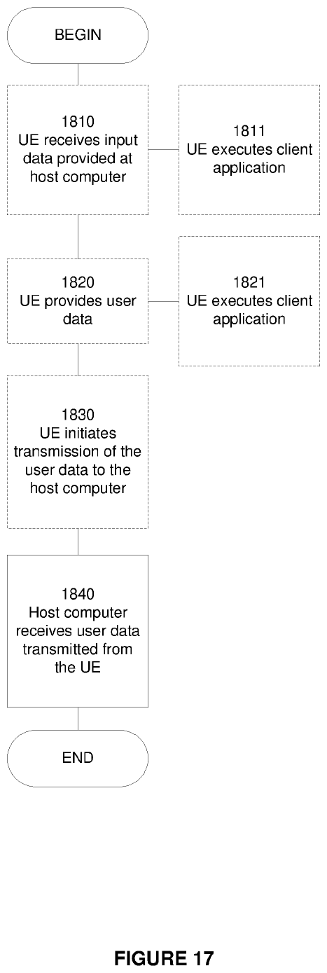

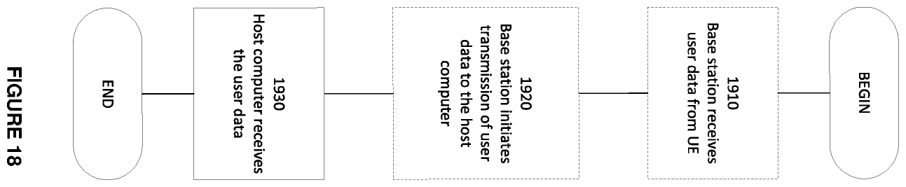

FIG. 17 is a flowchart illustrating a method implemented in a communication system, in accordance with one aspect. The communication system includes a host computer, a base station and a UE which may be those described with reference to FIG. 13 and FIG. 14. For simplicity of the present disclosure, only drawing references to FIG. 17 will be included in this section. In step 1810 (which may be optional), the UE receives input data provided by the host computer. Additionally or alternatively, in step 1820, the UE provides user data. In substep 1821 (which may be optional) of step 1820, the UE provides the user data by executing a client application. In substep 1811 (which may be optional) of step 1810, the UE executes a client application which provides the user data in reaction to the received input data provided by the host computer. In providing the user data, the executed client application may further consider user input received from the user. Regardless of the specific manner in which the user data was provided, the UE initiates, in substep 1830 (which may be optional), transmission of the user data to the host computer. In step 1840 of the method, the host computer receives the user data transmitted from the UE, in accordance with the teachings of the aspects described throughout this disclosure.

FIG. 18 is a flowchart illustrating a method implemented in a communication system, in accordance with one aspect. The communication system includes a host computer, a base station and a UE which may be those described with reference to FIG. 13 and FIG. 14. For simplicity of the present disclosure, only drawing references to FIG. 18 will be included in this section. In step 1910 (which may be optional), in accordance with the teachings of the aspects described throughout this disclosure, the base station receives user data from the UE. In step 1920 (which may be optional), the base station initiates transmission of the received user data to the host computer. In step 1930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more aspects of the present disclosure.

Aspects of the present disclosure present numerous advantages over the prior art. The network can quickly (de)activate PDCP duplication by an L1 signal, which is faster than MAC CE and RRC (re)configuration. This is extremely useful in the case when there is a need for a faster reaction to boost reliable transmission by PDCP duplication for the next message, e.g., when the survival time is short (e.g., in the range of 0.5 ms, 1 ms, 2 ms) for UL periodic traffic.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the aspects disclosed herein may be applied to any other aspect, wherever appropriate. Likewise, any advantage of any of the aspects may apply to any other aspects, and vice versa. Other objectives, features and advantages of the enclosed aspects will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein. As used herein, the term “configured to” means set up, organized, adapted, or arranged to operate in a particular way; the term is synonymous with “designed to.” As used herein, the term “substantially” means nearly or essentially, but not necessarily completely; the term encompasses and accounts for mechanical or component value tolerances, measurement error, random variation, and similar sources of imprecision. As used herein, the term “(de)activation” means “activation or deactivation,” or “deactivation or activation.”

Some of the aspects contemplated herein are described more fully with reference to the accompanying drawings. Other aspects, however, are contained within the scope of the subject matter disclosed herein. The disclosed subject matter should not be construed as limited to only the aspects set forth herein; rather, these aspects are provided by way of example to convey the scope of the subject matter to those skilled in the art.

### Representative Embodiments

### Group A Embodiments

1. A method, performed by a wireless device operative in a wireless communication network, of transmitting uplink data packets using Packet Data Convergence Protocol (PDCP) packet duplication, the method comprising:
   configuring a primary Radio Link Control (RLC) entity and at least a first secondary RLC entity for PDCP duplication in response to higher layer signaling from the network;
   receiving a Layer-1 (L1) signal from the network requesting one of activation or deactivation of PDCP duplication on the first secondary RLC entity;
   in response to the L1 signal, activating or deactivating, respectively, PDCP duplication on the first secondary RLC entity.
2. The method of embodiment 1, wherein the higher layer signaling configuring the first secondary RLC entity for PDCP duplication comprises Radio Resource Control (RRC) signaling.
3. The method of embodiment 1, wherein the L1 signal requesting one of activation or deactivation of PDCP duplication on the first secondary RLC entity comprises Downlink Control Information (DCI) transmitted on a Physical Downlink Control Channel (PDCCH).
4. The method of embodiment 3, wherein the L1 signal requesting one of activation or deactivation of PDCP duplication on the first secondary RLC entity comprises a Configured Grant (CG) type-2 activation or deactivation DCI command, respectively.
5. The method of embodiment 4, wherein a Logical Channel ID (LCID) is associated with the first secondary RLC entity.
6. The method of embodiment 5, wherein
   the CG type-2 activation or deactivation DCI command includes a CG index; and
   configuring at least the first secondary RLC entity for PDCP duplication comprises further configuring the first secondary RLC entity with an association between its LCID and the CG index in the CG type-2 activation or deactivation DCI command.
7. The method of embodiment 3, wherein
   configuring at least the first secondary RLC entity for PDCP duplication comprises associating a primary RLC entity and at least the first secondary RLC entity with a Data Radio Bearer (DRB); and
   activating or deactivating PDCP duplication in response to the L1 signal comprises activating or deactivating PDCP duplication on a plurality of secondary RLC entities associated with the DRB.
8. The method of embodiment 7 wherein the plurality of secondary RLC entities comprises all secondary RLC entities associated with the DRB.
9. The method of embodiment 7 wherein the plurality of secondary RLC entities comprises a configured subset of secondary RLC entities associated with the DRB.
10. The method of embodiment 7 wherein the plurality of secondary RLC entities comprises a default subset of secondary RLC entities associated with the DRB.
11. The method of any preceding embodiment further comprising:
   when PDCP duplication is deactivated for the first secondary RLC entity, and prior to receiving an L1 signal to activate PDCP duplication for the first secondary RLC entity, preparing PDCP packets for transmission by the first secondary RLC entity at each PDCP duplication transmission opportunity, in anticipation of receiving the L1 PDCP activation signal.
12. The method of embodiment 11 wherein preparing PDCP packets for transmission by the first secondary RLC entity at each PDCP duplication transmission opportunity comprises using properties from the CG to prepare the PDCP packets for transmission.
13. The method of embodiment 1, wherein the wireless device transmits the uplink data packets in a Time Sensitive Communication (TSC) Quality of Service (QoS) flow.
AA. The method of any of the previous embodiments, further comprising:
   providing user data; and
   forwarding the user data to a host computer via the transmission to the base station.

### Group B Embodiments [Numbering Intentionally Skipped to 51]

51. A method, performed by a base station operative in a wireless communication network, of receiving uplink data packets using Packet Data Convergence Protocol (PDCP) packet duplication, the method comprising:
   sending configuration information to a wireless device via higher layer signaling to configure a primary Radio Link Control (RLC) entity and at least a first secondary RLC entity for PDCP duplication;
   in response to failing to receive a periodic packet from the primary RLC entity within a predetermined Packet Delay Budget (PDB) after the packet arrival time, sending a command to the wireless device, via L1 signaling, activating PDCP duplication for at least the first secondary RLC entity.
52. The method of embodiment 51, further comprising:
   in response to receiving a periodic packet from either the primary RLC entity or the first secondary RLC entity within the delay budget, sending a command to the wireless device, via L1 signaling, deactivating PDCP duplication for at least the first secondary RLC entity.
53. The method of embodiment 51, wherein the higher layer signaling configuring the first secondary RLC entity for PDCP duplication comprises Radio Resource Control (RRC) signaling.
54. The method of embodiment 51, wherein the L1 signal requesting one of activation or deactivation of PDCP duplication on the first secondary RLC entity comprises Downlink Control Information (DCI) transmitted on a Physical Downlink Control Channel (PDCCH).
55. The method of embodiment 54, wherein the L1 signal requesting one of activation or deactivation of PDCP duplication on the first secondary RLC entity comprises a Configured Grant (CG) type-2 activation or deactivation DCI command, respectively.
56. The method of embodiment 54, wherein a Logical Channel ID (LCID) is associated with the first secondary RLC entity.
57. The method of embodiment 56, wherein
   the CG type-2 activation or deactivation DCI command includes a CG index; and
   information to configure at least the first secondary RLC entity for PDCP duplication comprises information to configure the first secondary RLC entity with an association between its LCID and the CG index in the CG type-2 activation or deactivation DCI command.
58. The method of embodiment 54, wherein
   information to configure at least the first secondary RLC entity for PDCP duplication comprises information to associate a primary RLC entity and at least the first secondary RLC entity with a Data Radio Bearer (DRB); and
   the command activating PDCP duplication for at least the first secondary RLC entity activates duplication on a plurality of secondary RLC entities associated with the DRB.
59. The method of embodiment 58 wherein the plurality of secondary RLC entities comprises all secondary RLC entities associated with the DRB.
60. The method of embodiment 58 wherein the plurality of secondary RLC entities comprises a configured subset of secondary RLC entities associated with the DRB.
61. The method of embodiment 58 wherein the plurality of secondary RLC entities comprises a default subset of secondary RLC entities associated with the DRB.
62. The method of embodiment 51 wherein the base station receives uplink data packets in a Time Sensitive Communication (TSC) Quality of Service (QOS) flow.
BB. The method of any of the previous Group B embodiments, further comprising:
   obtaining user data; and
   forwarding the user data to a host computer or a wireless device.

### Group C Embodiments

C1. A wireless device configured to perform any of the steps of any of the Group A embodiments.
C2. A wireless device comprising:
   processing circuitry configured to perform any of the steps of any of the Group A embodiments; and
   power supply circuitry configured to supply power to the wireless device.
C3. A wireless device comprising:
   processing circuitry and memory, the memory containing instructions executable by the processing circuitry whereby the wireless device is configured to perform any of the steps of any of the Group A embodiments.
C4. A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
C5. A computer program comprising instructions which, when executed by at least one processor of a wireless device, causes the wireless device to carry out the steps of any of the Group A embodiments.
C6. A carrier containing the computer program of embodiment C5, wherein the carrier is one of an electronic signal, optical signal, radio signal, or computer readable storage medium.
C7. A base station configured to perform any of the steps of any of the Group B embodiments.
C8. A base station comprising:
   processing circuitry configured to perform any of the steps of any of the Group B embodiments;
   power supply circuitry configured to supply power to the base station.
C9. A base station comprising:
   processing circuitry and memory, the memory containing instructions executable by the processing circuitry whereby the base station is configured to perform any of the steps of any of the Group B embodiments.
C10. A computer program comprising instructions which, when executed by at least one processor of a base station, causes the base station to carry out the steps of any of the Group B embodiments.
C11. A carrier containing the computer program of embodiment C10, wherein the carrier is one of an electronic signal, optical signal, radio signal, or computer readable storage medium.

### Group D Embodiments

D1. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
D2. The communication system of the pervious embodiment further including the base station.
D3. The communication system of the previous 2 embodiments, further including the UE, wherein the UE is configured to communicate with the base station.
D4. The communication system of the previous 3 embodiments, wherein:
   the processing circuitry of the host computer is configured to execute a host application, thereby providing the user data; and
   the UE comprises processing circuitry configured to execute a client application associated with the host application.
D5. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
D6. The method of the previous embodiment, further comprising, at the base station, transmitting the user data.
D7. The method of the previous 2 embodiments, wherein the user data is provided at the host computer by executing a host application, the method further comprising, at the UE, executing a client application associated with the host application.
D8. A user equipment (UE) configured to communicate with a base station, the UE comprising a radio interface and processing circuitry configured to perform any of the previous 3 embodiments.
D9. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
D10. The communication system of the previous embodiment, wherein the cellular network further includes a base station configured to communicate with the UE.
D11. The communication system of the previous 2 embodiments, wherein:
   the processing circuitry of the host computer is configured to execute a host application, thereby providing the user data; and
   the UE's processing circuitry is configured to execute a client application associated with the host application.
D12. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
D13. The method of the previous embodiment, further comprising at the UE, receiving the user data from the base station.
D14. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
D15. The communication system of the previous embodiment, further including the UE.
D16. The communication system of the previous 2 embodiments, further including the base station, wherein the base station comprises a radio interface configured to communicate with the UE and a communication interface configured to forward to the host computer the user data carried by a transmission from the UE to the base station.
D17. The communication system of the previous 3 embodiments, wherein:
   the processing circuitry of the host computer is configured to execute a host application; and
   the UE's processing circuitry is configured to execute a client application associated with the host application, thereby providing the user data.
D18. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
D19. A method implemented in a communication system including a host computer, a base station and a user equipment (UE), the method comprising: at the host computer, receiving user data transmitted to the base station from the UE, wherein the UE performs any of the steps of any of the Group A embodiments.
D20. The method of the previous embodiment, further comprising, at the UE, providing the user data to the base station.
D21. The method of the previous 2 embodiments, further comprising:
   at the UE, executing a client application, thereby providing the user data to be transmitted; and
   at the host computer, executing a host application associated with the client application.
D22. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
D24. The communication system of the previous embodiment further including the base station.
D25. The communication system of the previous 2 embodiments, further including the UE, wherein the UE is configured to communicate with the base station.
D26. The communication system of the previous 3 embodiments, wherein:
   the processing circuitry of the host computer is configured to execute a host application;
   the UE is configured to execute a client application associated with the host application, thereby providing the user data to be received by the host computer.
D27. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
D28. The method of the previous embodiment, further comprising at the base station, receiving the user data from the UE.
D29. The method of the previous 2 embodiments, further comprising at the base station, initiating a transmission of the received user data to the host computer.

1-28. (canceled)

29. A method, performed by a wireless device operative in a wireless communication network, of transmitting uplink data packets using Packet Data Convergence Protocol (PDCP) packet duplication, the method comprising:
in response to higher layer signaling from the network, configuring a primary Radio Link Control (RLC) entity and a plurality of secondary RLC entities for PDCP duplication in association with a Data Radio Bearer (DRB);
receiving a Layer-1 (L1) signal from the network requesting activation of PDCP duplication for a first secondary RLC entity associated with the DRB;
in response to the L1 signal, activating PDCP duplication on all of the plurality of secondary RLC entities in association with the DRB.

30. The method of claim 29, wherein the L1 signal requesting activation of PDCP duplication for the first secondary RLC entity comprises Downlink Control Information (DCI) transmitted on a Physical Downlink Control Channel (PDCC).

31. The method of claim 30, wherein the L1 signal requesting activation of PDCP duplication for the first secondary RLC entity comprises a Configured Grant (CG) type-2 activation DCI command comprising:
a CG index; and
a Logical Channel ID (LCID) associated with the first secondary RLC entity.

32. The method of claim 31, wherein configuring the plurality of secondary RLC entities for PDCP duplication comprises further configuring the first secondary RLC entity with an association between its LCI and the CG index in a DCI command.

33. A wireless device operative in a wireless communication network, comprising:
communication circuitry configured to wirelessly communicate with the network; and
processing circuitry operatively connected to the communication circuitry and configured to
in response to higher layer signaling from the network, configure a primary Radio Link Control (RLC) entity and a plurality of secondary RLC entities for Packet Data Convergence Protocol (PDCP) duplication;
receive a Layer-1 (L1) signal from the network requesting activation of PDCP duplication for a first secondary RLC entity associated with the DRB;
in response to the L1 signal, activate PDCP duplication on all of the plurality of secondary RLC entities in association with the DRB.

34. The wireless device of claim 33, wherein the L1 signal requesting activation of PDCP duplication for the first secondary RLC entity comprises Downlink Control Information (DCI) transmitted on a Physical Downlink Control Channel (PDCC).

35. The wireless device of claim 34, wherein the L1 signal requesting activation of PDCP duplication for the first secondary RLC entity comprises a Configured Grant (CG) type-2 activation DCI command comprising:
a CG index; and
a Logical Channel ID (LCID) associated with the first secondary RLC entity.

36. The method of claim 35, wherein configuring the plurality of secondary RLC entities for PDCP duplication comprises further configuring the first secondary RLC entity with an association between its LCI and the CG index in a DCI command.

37. A method, performed by a base station operative in a wireless communication network, of receiving uplink data packets using Packet Data Convergence Protocol (PDCP) packet duplication, the method comprising:
sending configuration information to a wireless device via higher layer signaling to configure a primary Radio Link Control (RLC) entity and a plurality of secondary RLC entities for PDCP duplication in association with a Data Radio Bearer (DRB) and
sending a command to the wireless device, via L1 signaling, activating PDCP duplication for all of the plurality of secondary RLC entities in association with the DRB.

38. The method of claim 37, further comprising:
in response to failing to receive a periodic packet from the primary RLC entity within a predetermined Packet Delay Budget (PDB) after the packet arrival time, sending the command to the wireless device, via L1 signaling, activating PDCP duplication for all of the plurality of secondary RLC entities.

39. The method of claim 37, wherein the L1 signal requesting activation of PDCP duplication for the first secondary RLC entity comprises Downlink Control Information (DCI) transmitted on a Physical Downlink Control Channel (PDCC).

40. The method of claim 39, wherein the L1 signal requesting activation of PDCP duplication for the first secondary RLC entity comprises a Configured Grant (CG) type-2 activation DCI command comprising:
a CG index; and
a Logical Channel ID (LCID) associated with the first secondary RLC entity.

41. The method of claim 40, wherein configuring the plurality of secondary RLC entities for PDCP duplication comprises further configuring the first secondary RLC entity with an association between its LCI and the CG index in a DCI command.

42. The method of claim 37 wherein the base station receives uplink data packets in a Time Sensitive Communication (TSC) Quality of Service (QOS) flow.

43. A base station operative in a wireless communication network, comprising:
communication circuitry configured to wirelessly communicate with wireless devices; and
processing circuitry operatively connected to the communication circuitry and configured to
send configuration information to a wireless device via higher layer signaling to configure a primary Radio Link Control (RLC) entity and a plurality of secondary RLC entities for Packet Data Convergence Protocol (PDCP) packet duplication in association with a Data Radio Bearer (DRB); and
send a command to the wireless device, via Layer-1 (L1) signaling, activating PDCP duplication for all of the plurality of secondary RLC entities.

44. The base station of claim 43, wherein the processing circuitry is further configured to:
in response to failing to receive a periodic packet from the primary RLC entity within a predetermined Packet Delay Budget (PDB) after the packet arrival time, send the command to the wireless device, via Layer-1 (L1) signaling, activating PDCP duplication for all of the plurality of secondary RLC entities.

45. The base station of claim 44, wherein the L1 signal requesting activation of PDCP duplication for the first secondary RLC entity comprises Downlink Control Information (DCI) transmitted on a Physical Downlink Control Channel (PDCC).

46. The base station of claim 45, wherein the L1 signal requesting activation of PDCP duplication for the first secondary RLC entity comprises a Configured Grant (CG) type-2 activation DCI command comprising:
a CG index; and
a Logical Channel ID (LCID) associated with the first secondary RLC entity.

47. The method of claim 46, wherein configuring the plurality of secondary RLC entities for PDCP duplication comprises further configuring the first secondary RLC entity with an association between its LCI and the CG index in a DCI command.

48. The base station of claim 43 wherein the base station receives uplink data packets in a Time Sensitive Communication (TSC) Quality of Service (QOS) flow.
